(19) United States
(12) Patent Application Publication
(10) Pub. No.: US 2022/0092702 A1
(43) Pub. Date: Mar. 24, 2022

(54) SYSTEMS AND METHODS FOR AUDITING CASH

(71) Applicant: PricewaterhouseCoopers Solutions Limited, London (GB)

(72) Inventor: Gary RAPSEY, London (GB)

(73) Assignee: PricewaterhouseCoopers Solutions Limited, London (GB)

(21) Appl. No.: 17/026,091

(22) Filed: Sep. 18, 2020

(51) Int. Cl. G06Q 40/00; G06Q 40/02

(52) U.S. Cl. CPC G06Q 40/125; G06Q 40/02

(57) ABSTRACT

A system for performing an audit of cash or cash equivalents and displaying a status of the audit includes one or more programs configured for execution by the one or more processors, the one or more programs including instructions for: displaying a first graphical user interface including a request for a first financial information, in response to detecting the first financial information, generating a plurality of requests, and mapping cash accounts or cash equivalent accounts of the first financial information based on responses to the plurality of requests; requesting second financial information based on mapping; auditing the first financial information via a plurality of cash tests or a plurality of cash equivalent tests to determine, respectively, whether the cash accounts or the cash equivalent accounts of the first financial information agree with the second financial information; and displaying a second graphical user interface visually summarizing the status of the audit.

### FIELD OF THE DISCLOSURE

The present disclosure relates to audit of cash, and more specifically, to a system and graphical user interfaces for auditing cash.

### BACKGROUND OF THE DISCLOSURE

A traditional cash audit process involves a human auditor who reviews the cash and/or cash equivalent bank accounts and determines whether the cash and/or cash equivalent bank accounts agree with verifying documentation (such as bank confirmations). If the accounts do not agree with the verifying documentation, the auditor identifies the line items that do not agree. This traditional cash audit process is a manual process for auditing entities having minimal or extensive financial portfolios. Furthermore, although the traditional cash audit process has its benefits, it does not provide a visualization of the audit progress for quickly viewing a status of the audit.

### SUMMARY OF THE DISCLOSURE

Applicants have discovered systems and methods that enable a complete audit of cash, decrease the risk of manual error in the audit of cash, improves quality and consistency of the audit of cash, and provide a visual user interface for initiating, reviewing, and finalizing the audit of cash. The systems and methods described herein are configured to automatically read, understand and test information associated with cash bank accounts, increase time efficiency compared to the traditional cash audit process, and display results accordingly in a graphical user interface. The systems and methods described herein provide an audit tool configured to perform an audit of cash bank accounts and/or cash equivalent bank accounts, visualize the progress of the audit from start to finish via user-selectable status icons, request user input as necessary for the audit, and automatically update the user-selectable status icons as the audit progresses and based on the input from the user.

In the following description of the disclosure and embodiments, reference is made to the accompanying drawings in which are shown, by way of illustration, specific embodiments that can be practiced. It is to be understood that other embodiments and examples can be practiced, and changes can be made, without departing from the scope of the disclosure.

In addition, it is also to be understood that the singular forms “a”, “an,” and “the” used in the following description are intended to include the plural forms as well, unless the context clearly indicates otherwise. It is also to be understood that the term “and/or,” as used herein, refers to and encompasses any and all possible combinations of one or more of the associated listed items. It is further to be understood that the terms “includes,” “including,” “comprises,” and/or “comprising,” when used herein, specify the presence of stated features, integers, steps, operations, elements, components, and/or units, but do not preclude the presence or addition of one or more other features, integers, steps, operations, elements, components, units, and/or groups thereof.

In some embodiments, a system for performing an audit of cash or cash equivalents and displaying a status of the audit includes: a display; one or more processors; memory; one or more programs configured for execution by the one or more processors, the one or more programs including instructions for: displaying a first graphical user interface that includes a request for a first financial information, the first financial information that includes a description of accounts and a designation of whether the accounts are cash accounts or cash equivalent accounts; in response to detecting the first financial information, generating a plurality of requests, receiving responses to the plurality of requests, and mapping the cash accounts or the cash equivalent accounts of the first financial information based on responses to the plurality of requests; requesting second financial information based on the mapping of the cash accounts or the cash equivalent accounts of the first financial information; detecting the second financial information; in response to detecting the second financial information, auditing the first financial information via a plurality of cash tests or a plurality of cash equivalent tests to determine, respectively, whether the cash accounts or the cash equivalent accounts of the first financial information agree with the second financial information; and displaying a second graphical user interface visually summarizing the status of the audit, the second graphical user interface comprising a dashboard illustrating a level of completion of each test associated with each cash account or each cash equivalent account being audited.

In any of these embodiments, the dashboard may include user-selectable status icons for illustrating a level of completion of each test for each cash account or cash equivalent account, and wherein the one or more programs may include instructions for automatically updating the level of completion of each test as the audit progresses.

In any of these embodiments, each user-selectable status icons may have either a first shape to indicate that a corresponding test of the plurality of cash tests or of the plurality of cash equivalents tests is completed or a second shape to indicate that the corresponding test is pending.

In any of these embodiments, the first shape may have either a first color to indicate that the corresponding test is completed and does not include a disagreement between the first financial information and the second financial information, a second color to indicate that the corresponding test is completed and reviewed, or a third color to indicate that the corresponding test is completed and includes at least one disagreement between the first financial information and the second financial information.

In any of these embodiments, the second shape may have either a first color to indicate a possible disagreement, a second color to indicate one or more actions to be completed by a user, a third color to indicate one or more types of actions to be completed, or a fourth color to indicate a request for third financial information.

In any of these embodiments, the second financial information may include one or more documents types, the document types including one or more of a bank reconciliation, a bank statement, a bank confirmation, and supporting evidence for a bank reconciling item for one or more cash account or cash equivalent account, each document type may comprise a specific format.

In any of these embodiments, the specific format of a bank reconciliation may include a single CSV or Excel files per cash or cash equivalent account, the specific format of a bank statement may include a single CSV or Excel files, the specific format of a bank confirmation may include a PDF, and the specific format for supporting evidence for a bank reconciling item may include a PDF.

In any of these embodiments, the second graphical user interface may comprise a first user-selectable summary of cash accounts and a second user-selectable summary of cash equivalent accounts, the first user-selectable summary and the second user-selectable summary are configured to automatically update as the audit progresses.

In any of these embodiments, the one or more programs may include instructions for: detecting a first input that includes selection of either the first user-selectable summary or the second user-selectable summary; in response to detecting the first input that may include selection of the first user-selectable summary, displaying on the dashboard user-selectable status icons for illustrating a level of completion of each cash test for each cash account; and in response to detecting the second input that may include selection of the second selectable summary, displaying on the dashboard user-selectable status icons for illustrating a level of completion of each cash equivalent test for each cash equivalent account.

In any of these embodiments, the second graphical user interface may comprise a third summary including key points of cash and cash equivalent accounts.

In any of these embodiments, the dashboard may comprise key client information associated with the cash accounts or the cash equivalent accounts.

In any of these embodiments, the dashboard may comprise a header including header icons configured to filter and sort the dashboard based on user selection of header icons.

In some embodiments, a method for performing an audit of cash or cash equivalents and displaying a status of the audit includes: at a computer system including one or more processor, memory, and a display displaying a first graphical user interface that includes a request for a first financial information, the first financial information including a description of accounts and a designation of whether the accounts are cash accounts or cash equivalent accounts; in response to detecting the first financial information, generating a plurality of requests, receiving responses to the plurality of requests, and mapping the cash accounts or the cash equivalent accounts of the first financial information; requesting second financial information based on the mapping of the cash accounts or the cash equivalent accounts of the first financial information; detecting the second financial information; in response to detecting the second financial information, auditing the first financial information via a plurality of cash tests or a plurality of cash equivalent tests to determine, respectively, whether the cash accounts or the cash equivalent accounts of the first financial information agree with the second financial information; and displaying a second graphical user interface visually summarizing the status of the audit, the second graphical user interface including a dashboard illustrating a level of completion of each test associated with each cash account or each cash equivalent account being audited.

In any of these embodiments, the second graphical user interface may include a first user-selectable summary of cash accounts and a second user-selectable summary of cash equivalent accounts that automatically update as the audit progresses, and the method including: detecting a first input including selection of either the first user-selectable summary or the second user-selectable summary; in response to detecting the first input including selection of the first user-selectable summary, displaying on the dashboard user-selectable status icons for illustrating a level of completion of each cash test for each cash account; and in response to detecting the second input comprising selection of the second selectable summary, displaying on the dashboard user-selectable status icons for illustrating a level of completion of each cash equivalent test for each cash equivalent account.

In some embodiments, a system for performing an audit of financial information comprising cash or cash equivalent accounts includes: a display; one or more processors; memory; one or more programs configured for execution by the one or more processors, the one or more programs including instructions for: auditing financial items via a plurality of tests to determine whether the financial items agree with associated verification information; determining a status of each test, the status illustrating whether each test for each financial item comprises a request for one or more actions from a user; displaying a graphical user interface comprising a dashboard including a description of the financial items, a list of the plurality of tests for auditing the financial items, and a plurality of user-selectable status icons indicating the status of each test for each financial item; detecting a first input comprising selecting a first user-selectable status icon corresponding to a status of a first test of the plurality of tests associated with a first financial item of the financial items; in response to detecting the first input, displaying verification information associated with the first test and the first financial information, and if the status illustrates that the first test associated with the first financial information comprises the request for one or more actions from the user, then displaying the request for the one or more actions; detecting a second input comprising the selection of an option for responding to the one or more actions; and in response to detecting the second input, automatically updating the first user-selectable status icon of the dashboard based on the second input.

In any of these embodiments, the first test may be configured for assessing one of foreign exchange, bank reconciliation, reconciling items, and bank confirmation.

In any of these embodiments, verification information may include a list of user-selectable supporting documents.

In any of these embodiments, the verification information may be displayed on a pop-up panel.

In any of these embodiments, the verification information may include a second status of the first test associated with the first financial information and the second status may be configured to automatically update based on the second input.

In some embodiments, a method for performing an audit of financial information comprising cash or cash equivalent accounts includes: at a computer system including one or more processors, memory, and a display: auditing financial items via a plurality of tests to determine whether financial items agree with associated verification information; determining a status of each test, the status illustrating whether each test for each financial item includes a request for one or more actions from a user; displaying a graphical user interface including a dashboard that includes a description of the financial items, a list of the plurality of tests for auditing the financial items, and a plurality of user-selectable status icons indicating the status of each test for each financial item; detecting a first input that includes selecting a first user-selectable status icon corresponding to a status of a first test of the plurality of tests associated with a first financial item of the financial items; in response to detecting the first input, displaying verification information associated with the first test and the first financial information, and if the status illustrates that the first test associated with the first financial information includes the request for one or more actions from the user, then displaying the request for the one or more actions; detecting a second input comprising the selection of an option for responding to the one or more actions; and in response to detecting the second input, automatically updating the first user-selectable status icon of the dashboard based on the second input.

### BRIEF DESCRIPTION OF THE FIGURES

The invention will now be described, by way of example only, with reference to the accompanying drawings, in which:

FIG. 1 is a block diagram of an exemplary system for auditing cash and displaying progress of a cash audit.

FIG. 2 shows examples of a graphical user interface display, according to some embodiments.

FIG. 3 shows an exemplary trial balance 300, according to some embodiments.

FIGS. 4A and 4B show examples of a graphical user interface display illustrating a level of completion of a cash audit, according to the some embodiments.

FIGS. 5A-5D show examples of a GUI display illustrating selectable options regarding verification data, according to some embodiments.

FIG. 6 shows an example of a GUI display illustrating a supporting document that is determined by a test to agree with its associated bank account information, according to some embodiments.

FIG. 7 shows an example of a cash audit ready that is completed and reviewed, according to some embodiments.

FIG. 8 shows an example of a result of a foreign exchange test having no disagreements, according to some embodiments.

FIGS. 9A-9C show examples of results of a foreign exchange test having a trivial disagreement, according to some embodiments.

FIGS. 10A-10E show examples of results of a foreign exchange test having a non-trivial disagreement, according to some embodiments.

FIG. 11 illustrates an example of a hover selection of a GUI display, according to some embodiments.

FIGS. 12A and 12B illustrate examples of results of a bank reconciliation test when reconciliation is not expected, according to some embodiments.

FIG. 13A illustrates an example of a result of a bank reconciliation test when reconciliation is expected and no disagreements are identified, according to some embodiments.

FIG. 13B illustrates an example of a result of a bank reconciliation test when reconciliation is expected and a disagreement is identified, according to some embodiments.

FIGS. 14A and 14B illustrate examples of results of a reconciling item tests when no disagreements are identified and no further documentation should be considered, according to some embodiments.

FIGS. 15A-15D illustrate examples of results of a reconciling item tests when no disagreements are identified and further documentation should be considered, according to some embodiments.

FIGS. 16A-16E illustrate examples of results of a reconciling item test when a difference is identified, according to some embodiments.

FIGS. 17A and 17B illustrate examples of results of a bank confirmation test that indicate all fields of the bank confirmation match an associated GL, account number, account balance, and account currency, according to some embodiments.

FIGS. 18A-18E illustrate examples of a bank confirmation test that a difference between the bank confirmation and an associated GL, account number, account balance, or account currency has been identified, according to some embodiments.

FIGS. 19A-19E illustrate examples of adding bank accounts to a bank confirmation test, according to some embodiments.

FIG. 20A shows an example result of a financial condition test that indicates a credit rating is above a first threshold, according to some embodiments.

FIG. 20B shows an example result of a financial condition test that indicates a credit rating is below a first threshold, according to some embodiments.

FIG. 20C shows an example depicting that in response to a user hovering over a user-selectable icon, details regarding the credit rating comparison may be displayed, according to some embodiments.

FIGS. 21A and 21B illustrate examples of results of a financial condition test that indicate a credit rating is below a first threshold and a second threshold, according to some embodiments.

FIGS. 22A-22C illustrate examples of a partial review of the audit test, according to some embodiments.

FIGS. 23A-23C illustrate examples of a final review of the audit test, according to some embodiments.

FIG. 24 shows a flowchart of an exemplary method 2400 for performing an audit of cash or cash equivalents and displaying a status of the audit, according to some embodiments.

FIG. 25 shows a flowchart of an exemplary method 2500 for confirming an audit of financial information comprising cash or cash equivalent accounts, according to some embodiments.

FIG. 26 is a functional block diagram of a computing device, according to some embodiments.

### DETAILED DESCRIPTION OF THE DISCLOSURE

Described herein are systems and methods that enable users to input information at one or more steps for auditing cash, visually track the progress of the audit of cash, review a visual organization and results of the audit, and finalize the reviewed audit of cash. The audit of cash may be configured to determine whether bank account information agrees with associated verification data, identify differences (if any) between the bank account information and the associated verification information, and display graphical indicators that illustrate whether any differences were identified during assessment. In some embodiments, the graphical indicators may be arranged on a GUI display so that a user may quickly interpret which accounts agree or may not agree with verification data. In some embodiments, the graphical GUI display may be configured to provide a status overview of the audit process via a plurality of user-selectable icons illustrating a status of each assessment for each account displayed on the GUI display. The shape and color of the user-selectable status icons may be configured to illustrate status information. Upon user-selection of the one of the user-selectable status icons, additional assessment information may be displayed. The additional assessment information may include one or more requests for a user to review. The user may select an action in response to the each request. In response to the user selection, the additional information and the status overview is automatically updated.

In some embodiments, the systems and methods described herein improve audit speed and efficiency by automating a majority of the audit of cash. In some embodiments at least 70% of the audit of cash may be automated, at least 80% of the audit of cash may be automated, at least 90% of the audit of cash may be automated, or at least 95% of the audit of cash may be automated. In some embodiments, the automation may use artificial intelligence that enables improved audit quality and consistent timely delivery. In some embodiments, artificial intelligence may be used to facilitate tasks that historically have been performed by junior human auditors. In some embodiments, the automation allows human auditors more time to focus on high risk and judgmental aspects of the audit. For example, the human auditors may have more time to stand back and consider results in the context of a business and industry as a whole, thus making the audit process more efficient.

A system for auditing cash and displaying progress of the audit may include an engagement module for receiving data for the audit and a data processing hub for auditing the received data and for generating a display summarizing progress of the audit. In some embodiments, the system may be configured to read and understand bank account information, and compare the bank account information with verification information to verify the accuracy and consistency of the bank account information. The system may be configured to graphically display whether any differences between the bank account information and the verification information were identified, request one or more actions from a user, and automatically update based on detecting a response to the request by the user.

### Setting Up a Cash Audit

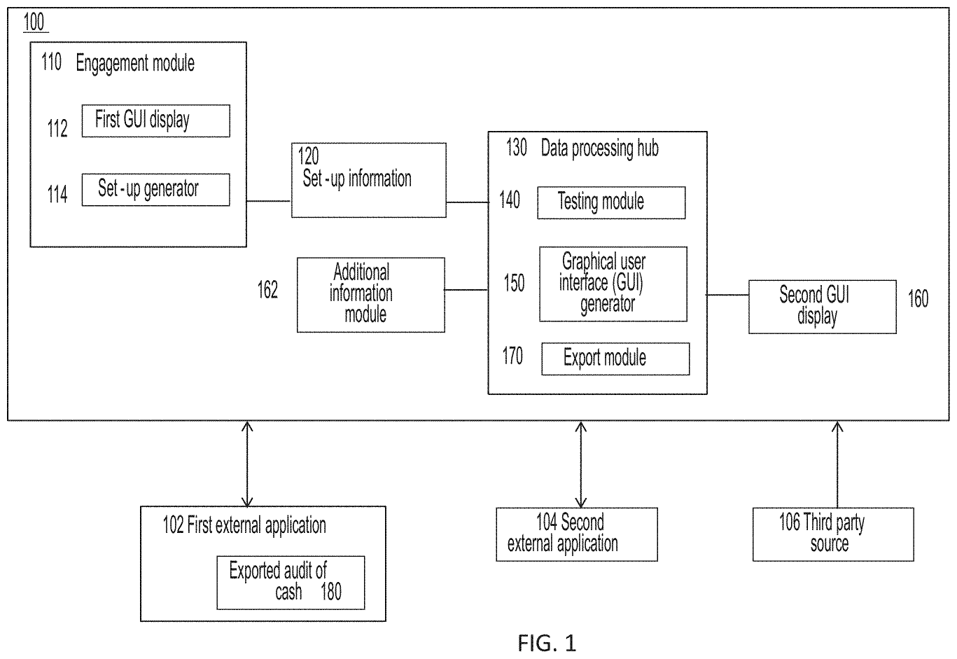

FIG. 1 illustrates an exemplary schematic of a system 100 for auditing cash and displaying progress of a cash audit. The system 100 may be accessed by an audit team. A client requesting an audit may provide financial data to be audited. The financial data may include financial records, one or more bank registers, bank accounts, and banking relationships associated with the bank accounts. The audit team may audit the financial data using system 100. The audit team may make requests for additional information as needed. Third party data may be used to provide independent corroboration/validation of the financial data as part of the audit testing and gathering of evidence.

In some embodiments, the system 100 may be automatically connected to external applications for receiving and sending information related to the audit. For example, system 100 may use information provided by a first external application 102 to automatically populate one or more fields of engagement data. The first external application 102 may provide, for example, materiality, engagement name, period review date, and financial year end date. In some embodiments, system 100 may generate a plurality of requests for a second external application 104 to provide additional information (such as a financial ledger, a record of financial transactions, a list of bank accounts and banking relationships of the bank accounts). The additional information may include bank statements and other documents that may serve as evidence or support for validating financial records and transactions. Each request of the plurality of requests may be generated as needed to complete the audit. In some embodiments, once the audit is complete, system 100 may send a final record of the audit to the first external application 102.

The system 100 may receive financial data provided by the client via the second external application 104. A minimum financial data for the audit may include bank register information, a trial balance (a summary of financial transactions by GL accounts), bank statements for every account, and bank reconciliations for each account. Requests for bank statements and bank reconciliation may be automatically generated based on one or more of the bank register and trial balance. In some embodiments, the system 100 may generate one or more templates that may be populated with information provided by a client. For example, the system may generate a template for a bank register.

The system 100 may request information from a third party 106 to verify data sources such as foreign exchange rates and financial credit ratings. For example, where applicable, the system 100 may use closing exchange rates from a third party 106 to verify that a foreign exchange rate used for the financial data is correct. The verification process may include independently performing conversion calculations necessary for the financial data and comparing them to the calculations received by the client. The system 100 may indicate whether the calculations received by the client is appropriate and reasonable based on the calculations performed by the system 100. In some embodiments, the system 100 may use a third party 106 to provide a credit rating that the system 100 may use to verify if one or more financial institutions associated with the financial data is at risk for financial trouble or impairment. In some embodiments, the requests for information from a third party 106 may be generated automatically by the system 100.

The audit team may use the system 100 to perform audit procedures as needed. For example, the audit team may perform procedures to verify financial data, identify if additional supporting documentation is needed to verify financial data, and identify discrepancies associated with the financial data using the automated testing strategy of system 100.

System 100 may include an engagement module 110 and a data processing hub 130 for completing the audit of cash. In some embodiments, the engagement module 110 may include a first graphical user interface (GUI) display 112 configured to display requests for data for completing the audit of cash. The data received in response to the requests via the first GUI display 112 may include a designation of whether the accounts are cash accounts or cash equivalent accounts. In some embodiments, after receiving a response to a first request for data, a second request for data may be generated based on the response to the first request for data. In some embodiments, a plurality of requests may be generated in response to receiving responses to previous requests. In some embodiments, the engagement module may include a set-up generator 114 configured to generate a set-up information 120 based on data received in response to the requests via the first GUI display 112. In some embodiments, the set-up generator 114 may be configured to generate a plurality of requests for information that can be used to map the received information. The plurality of requests may include a series of separate requests configured to request information from the second external application 104. In some embodiments, the responses to the plurality of requests may be used to map cash accounts or cash equivalent accounts of the financial data. The plurality of requests may include templates that may be populated based on information provided by the client via the second external application 104.

The data may be received at an engagement module and stored securely. In some embodiments, the data may include a designation of users of the audit team that are allowed to access the data and the audit of the data. In some embodiments, the audit may be accessed by a minimum number of users to ensure the audit is reviewed by a user different from a user who initiated or edited the audit. For example, system 100 may be accessed by a minimum of two users. The audit team may set up the audit by providing engagement data such as engagement identification information (such as engagement name, audit unit name, legal entity name, dates, currency, year-end date, materiality), a list of bank accounts to be audited, and information associated with the bank accounts listed (such as bank name, local currency, bank account name, bank account number and associated general ledger (GL) account numbers). The engagement data may include a trial balance (final cash numbers) that is provided by the client. The trial balance may be received, for example in an Excel sheet format or in the client's system format. If applicable, the received trial balance may be transformed into a common data model format for further use in system 100. The common data format for a trial balance may include, for example, a list of GL account numbers, GL account descriptions, closing balances for banking period current period, and reporting currency. The engagement module 110 may include a set-up generator 114 configured to generate set-up information 120 for the audit. The set-up information 120 may be configured to map bank account information and GL accounts and include whether a bank account is classified as cash, cash equivalent, or as another asset type. Alternatively, in some embodiments, the set-up generator 114 may be configured to generate a plurality of requests for information that can be used to map bank account information and GL accounts and include whether a bank account is classified as cash, cash equivalent, or as another asset type. The plurality of requests may be include a series of separate requests configured to request information from the second external application 104. The plurality of requests may include templates that may be populated based on information provided by the client via the second external application 104. For example, the set-up generator 114 may generate a bank register template that may be populated by data received from the client via the external application 104. The bank accounts classified as cash accounts or cash equivalent accounts are selected to be further processed by the testing module 140.

In some embodiments, one or more requests for deliverables may be automatically requested based on set-up information 120. The deliverables may include one or more document types. The document types may include one or more of bank reconciliations, bank statements, bank confirmation, and supporting evidence for bank reconciling items. An example of a primary request for deliverables may include documentation regarding bank accounts, bank confirmation, and bank reconciliation. An example of a secondary request may include documentation for supporting bank account items selected for testing.

In some embodiments, the deliverables may be provided in a specific format. For example, bank reconciliations may be provided as single CSV or Excel files per bank account, bank statements as single CSV or Excel files, bank confirmation as PDF, and supporting evidence for reconciling items as PDF.

In some embodiments, in response to detecting the set-up information and client deliverables, the testing module may be configured to employ one or more tests based on whether the bank account is classified as a cash account or a cash equivalent account. For example, the testing module 140 may be configured to audit each bank account identified as either cash or cash equivalent respectively via a plurality of tests for cash accounts or a plurality of tests for cash equivalent accounts. In some embodiments, the audit may determine whether the bank account information from the set-up information agrees with the client deliverables. The plurality of tests for auditing cash accounts may include assessments of foreign exchange, bank reconciliation, reconciling items, bank confirmation, and financial condition of the bank. The plurality of tests for auditing cash equivalent accounts may include assessment of foreign exchange, and confirmation and classification of the cash equivalent bank accounts. In some embodiments, one or more of the tests for cash accounts and cash equivalent accounts may be the same.

The data processing hub 130 may include a graphical user interface (GUI) generator 150 to generate a GUI display 160 that shows a level of completion of the one or more plurality of tests. In some embodiments, while performing the one or more plurality of tests, the testing module 140 may request, via the graphical display 160, additional information or verification data as needed to complete the tests. The additional information or verification data may be received at the data processing hub 130 via an additional information module 162. Inclusion of the additional information or verification data in the one or more tests may progress a level of completion of the one or more tests, progress an overall level of completion of the audit, and update the graphical display 160 based on the progression of the one or more tests and the overall completion of the audit.

In some embodiments, the GUI generator 150 may generate a GUI display 160 that summarizes a level of completion of the each test of the audit. For example, the GUI display 160 may summarize a level of completion of each test performed by the testing module 140, summarize a review status of each test, and summarize a review status of the overall audit. In some embodiments, an export module 170 may export a completed and reviewed audit of cash 180 to another system for further verification and procedures.

In some embodiments, the tests read and understand bank account information provided to an engagement module (such as engagement module 110), compare the bank account information with deliverables (such as deliverables provided to the additional information module 162) to verify the accuracy and consistency of the bank account information. The tests may be configured to identify differences between the bank account information and the deliverables, and graphically indicate that whether any differences were identified. In some embodiments, the graphical indications may be arranged on a GUI display (such as the second GUI display 160) so that a user may quickly interpret which accounts agree or may not agree with associated deliverables. In some embodiments, the GUI display (such as the second GUI display 160) may include an array of user-selectable status icons so that a user may easily and quickly capture a current status of the each displayed audit test as well as the overall status of the audit. In some embodiments, the second GUI display 160 may be an updated display of the first GUI display 112 to show different information and different steps of the audit process.

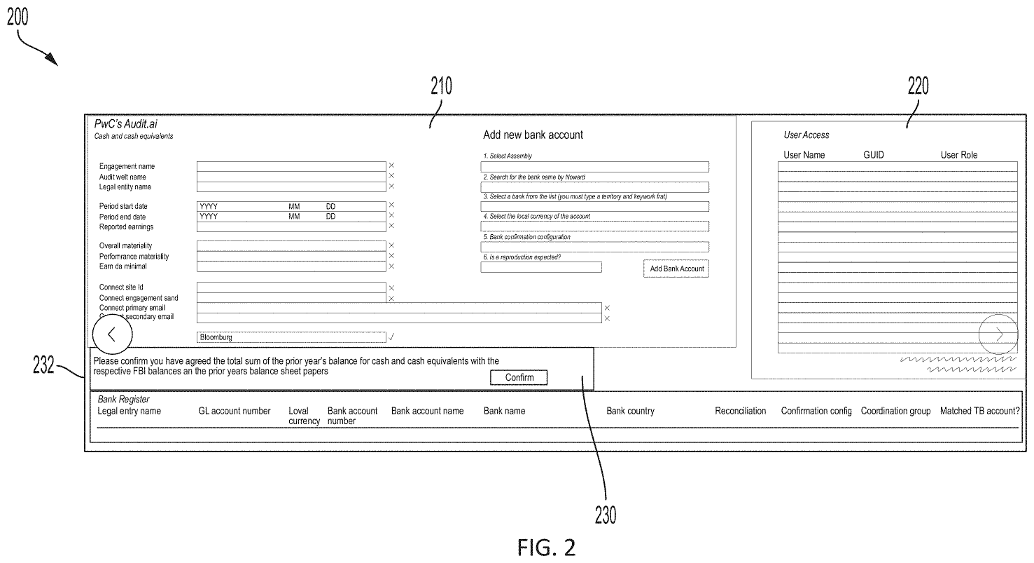

To initiate a cash audit, a user may provide audit details via a GUI display (such as the first GUI display 112). In some embodiments, the first GUI display may include a plurality of fields to be completed by a user. FIG. 2 shows an example of a first GUI display 200, according to some embodiments. The first GUI display 200 may be displayed, for example, as the first GUI display 112 of FIG. 1. In some embodiments, the first GUI display 200 may include engagement identification fields 210, user access fields 220, and bank register fields 230. The engagement identification fields 210 may include a first section for requesting engagement information such as engagement name, audit unit name, legal entity name, dates, currency, year-end date, materiality, and details associated with one or more external applications. In response to receiving the engagement information in the first section, the first GUI display 200 may illustrate that the engagement information fields of the first section are complete. In some embodiments, the engagement identification information 210 may include a second section for adding a bank account to a list of bank accounts to be audited. In some embodiments, the second section may be used to add a plurality of bank accounts to be audited. In some embodiments, the second section may be revisited to add a plurality of bank accounts one at a time. For each bank account to be audited, the second section is configured to request bank account information regarding the bank account to be added. The bank account information may include bank name, local currency, and bank confirmation configuration. In some embodiments, the bank account information may include whether reconciliation of the bank account is expected. In response to receiving the bank account information, the first GUI display 200 may display a bank register 232 based on the bank account information received. The bank register may include bank register fields 230.

In some embodiments, the user access fields 220 may include a user role for each user. The user role may include editing or reviewing one or more steps of the audit. In some embodiments, the user may confirm all prior year balances via the first GUI display.

In some embodiments, the bank register fields 232 may automatically populate once an individual bank account is added. For each bank account added, the bank register fields 232 includes a field for providing an associated general ledger (GL) account number, a bank account number, and a bank account name.

In some embodiments, the bank accounts in the bank register 232 are configured to be automatically compared to the trial balance received by an engagement module (such as engagement module 110) to determine if the bank accounts match the trial balance. Based on the determination, each account may be updated to include a color-or shape-based visual descriptors to indicate that the account and the trial balance match, do not match, or that the account should be reviewed. For example, if it is determined that the bank accounts match the trial balance, then the first GUI display (such as GUI display 112) may be configured to display a first color to indicate a match. If it is determined that the bank accounts do not match, then the first GUI display may be configured to display a second color to indicate that the account and the trial balance do not match. If it is determined that multiple GL accounts match to one bank account, then the first GUI display may be configured to display a third color to flag the account for further review. In some embodiments, further review may include a user ensuring that all associated GL accounts are included in the trial balance. In some embodiments, the visual designation to indicate that the account and the trial balance match, do not match, or that the account should be reviewed may be displayed via the bank register 232.

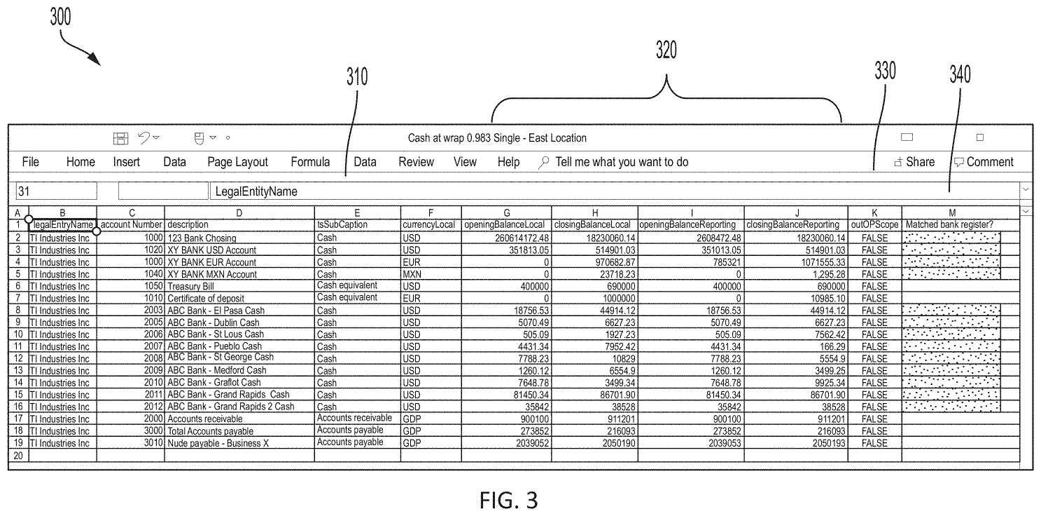

A display of the trial balance may include an asset categorization for each account of a bank register (such as bank register 232), opening and closing balances, a confirmation of whether each account listed in the trial balance is to be audited, and a color- or shape-based visual descriptor to indicate whether each account in the trial balance matches the bank register (such as bank register 232). A trial balance may be displayed via a GUI display (such as GUI display 112). FIG. 3 shows an exemplary trial balance 300, according to some embodiments. The trial balance 300, may include an asset categorization 310 for each account. Each account may be listed, for example, as either a cash account, cash equivalent account, accounts receivable, accounts payable, or as another type of asset. In some embodiments, only cash accounts may be selected for auditing. In some embodiments, only cash accounts and cash equivalent accounts may be selected for auditing. The trial balance 300 may include opening and closing balances 320. The opening and closing balances 320 may be used to determine current year and prior year end balances in both local and reporting currency. The trial balance 300 may include a confirmation 330 of whether each account listed in the trial balance is to be audited. The trial balance 300 may include a color-based visual descriptor 340 to indicate whether each account of the trial balance 300 matches a bank register (such as bank register 232). In some embodiments, the trial balance 300 may include a first color descriptor to indicate that the account matches the bank register. In some embodiments, the trial balance 300 may include a second color descriptor to indicate that there is no match for an account of the trial balance to an account in the bank register. Alternatively, the second color descriptor may indicate that the account is not to be audited.

### Graphical User Interface Display for Display Status of a Cash Audit

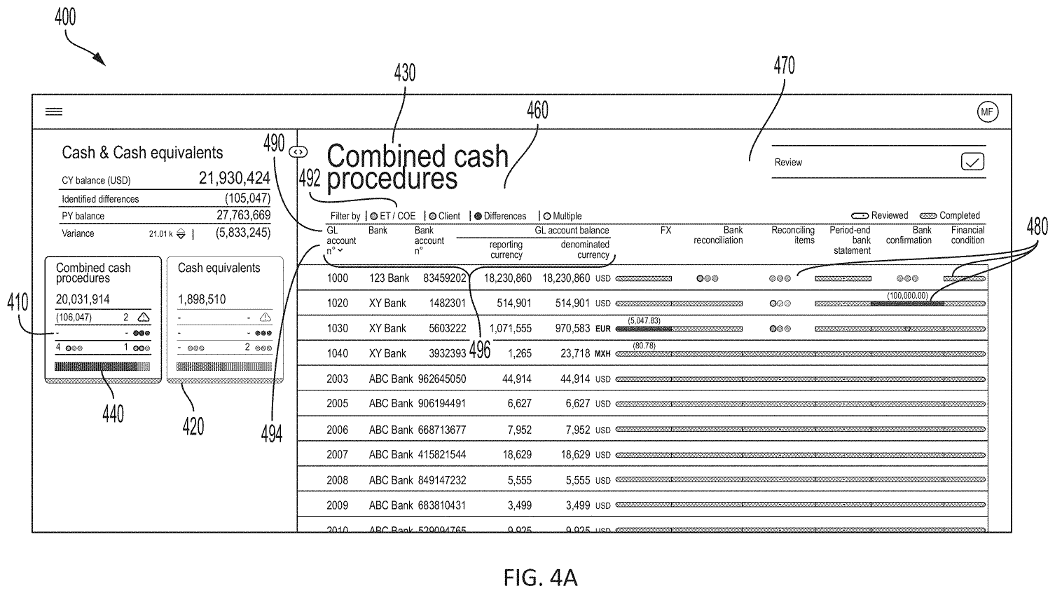

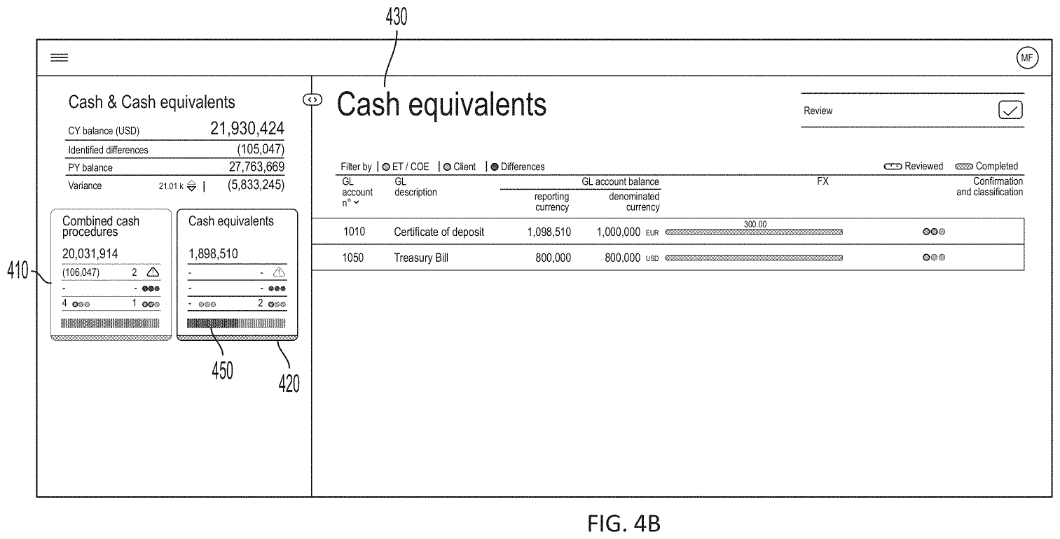

A GUI display may be configured to display a level of completion of each test of a cash audit. The display may include a plurality of summary panels and a dashboard. FIGS. 4A and 4B show examples of a GUI display 400 illustrating a level of completion of a cash audit, according to the some embodiments. The GUI display 400 is an example of the second GUI display 160 of FIG. 1. GUI 400 may include a plurality of summaries 410, 420 and a selected dashboard 430, according to some embodiments. The plurality of summaries may automatically update as the audit progresses. A first summary 410 of the plurality of summaries may show a summary of the audit for the cash accounts. A second summary 420 of the plurality of summaries may show a second summary progress of the audit for cash equivalents accounts. The first summary progress 410 and the second summary progress 420 may include a graphical progress bar 440, 450 that automatically updates respectively based on a level of completion of the audit of cash accounts and cash equivalent accounts. In some embodiments, a third summary may be displayed via GUI display 400. The third summary may display key points of the first and second summaries.

The dashboard may show information associated with cash accounts or cash equivalent accounts based on user selection via a GUI display. For example, in some embodiments, the user may select a first icon to configure the dashboard 430 to display a level of completion of tests performed on cash accounts and the user may select a second icon to configure the dashboard 430 to display a level of completion of tests performed on cash equivalent accounts. In some embodiments, the first icon is the first summary 410 and the second icon is the second summary 420.

In each dashboard configuration, the dashboard may include key client information associated with either the cash accounts or the cash equivalents accounts. For example, the key client information section 460 may include an entry for each bank account and its associated GL account. In some embodiments, a single bank account may be associated with a plurality of GL accounts. The key client information section 430 may include, for example, for each bank account entry displayed, an associated GL account number, a bank name and a bank account number, and a GL account balance in reported and denominated currency.

In each dashboard configuration, the dashboard may include a test section configured to list tests for auditing either the cash accounts or the cash equivalents accounts. For example, the test status section 470 may include a listing of tests in progress, pending, or completed for each GL account listed in the key client information section 460. The tests may include, for example, assessments of foreign exchange, bank reconciliation, reconciling items, and bank financial confirmation condition tests for each GL account.

In some embodiments, each dashboard may include a first header that includes first header icons configured to filter dashboard based on which first header icon is selected. For example, first header 490 may be filtered by user-selectable categories 492 that allow the dashboard to be filtered based on actions to be completed by the audit team, actions to be completed by client, tests that identify differences, and tests that have multiple pending states. In some embodiments, each dashboard may include a second header that includes second header icons configured to sort dashboard based on which second header icon are selected. For example, second header 494 may be sorted by user-selectable categories 496 that allow the dashboard to be sorted based on GL information.

In each dashboard configuration, the dashboard may include user-selectable status icons indicating a status of each test for each bank account displayed on the dashboard. The tests are configured to determine whether bank account information agree with verification data associated with the bank account information. The user-selectable status icons may be configured to display the status of each test based on color and shape of the status icon. FIG. 4A shows examples of user-selectable status icons 480. The user-selectable icons may be any shape, for example the user-selectable status icons may have a rectangular, circular, or triangular shape. A first shape may indicate that a test has been completed. Different colors of the first shape may indicate different type of levels of completion. For example, a first color of the first shape may indicate that a task has been completed and does not include a disagreement between bank account information agree with verification data, a second color of the first shape may indicate that a task has been completed and reviewed, and a third color of the first shape may indicate that a task has been completed and includes at least one disagreement between the bank account information and the verification data. In some embodiments, a color may indicate that the at least one disagreement identified is either trivial or non-trivial difference. A non-trivial difference may be a difference between the bank account information and the verification data that exceeds a threshold.

In some embodiments, a second shape may be indicative that a test/test is pending. Different colors of the second shape may indicate that different types of pending states. For example, a first color of the second shape may indicate that a task has may include a possible error or disagreement, a second color of the second shape may indicate that an action by a user is expected for the test to continue, a third color of the second shape may indicate that a task is awaiting completion of other tasks to continue, a fourth color of the second shape may indicate that a task is awaiting client information to continue, and a fifth color of the second shape may indicate that a task may include that one or more the above-mentioned pending states are applicable.

In some embodiments, additional status descriptors may indicate other information regarding the status of a test associated with a given account displayed on the dashboard. In some embodiments, symbols positioned on or adjacent the first shape may indicate that an automated outcome of the test has been edited manually by a user or that the test is not relevant for the associated bank account entry of the dashboard. In some embodiments, a value positioned on or near the first shape indicates a difference between the bank account information and verification data has been identified. If the value is trivial, the first bar is a first bar color. If the value is non-trivial, then the first bar is a second bar color. In some embodiments, a test is configured to determine whether a value is trivial or non-trivial based on a designated threshold.

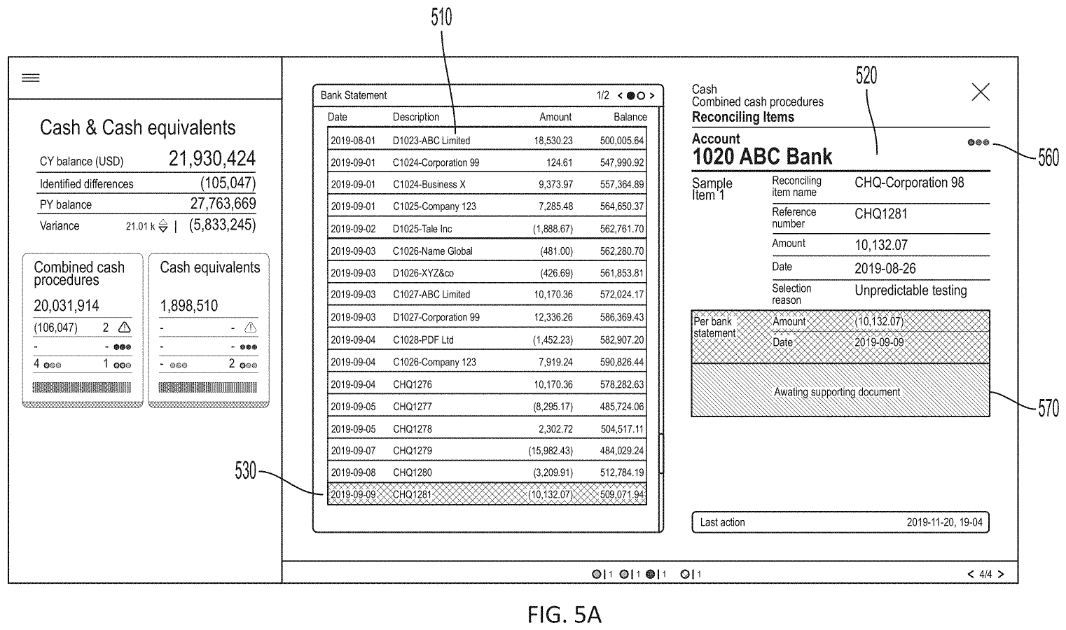

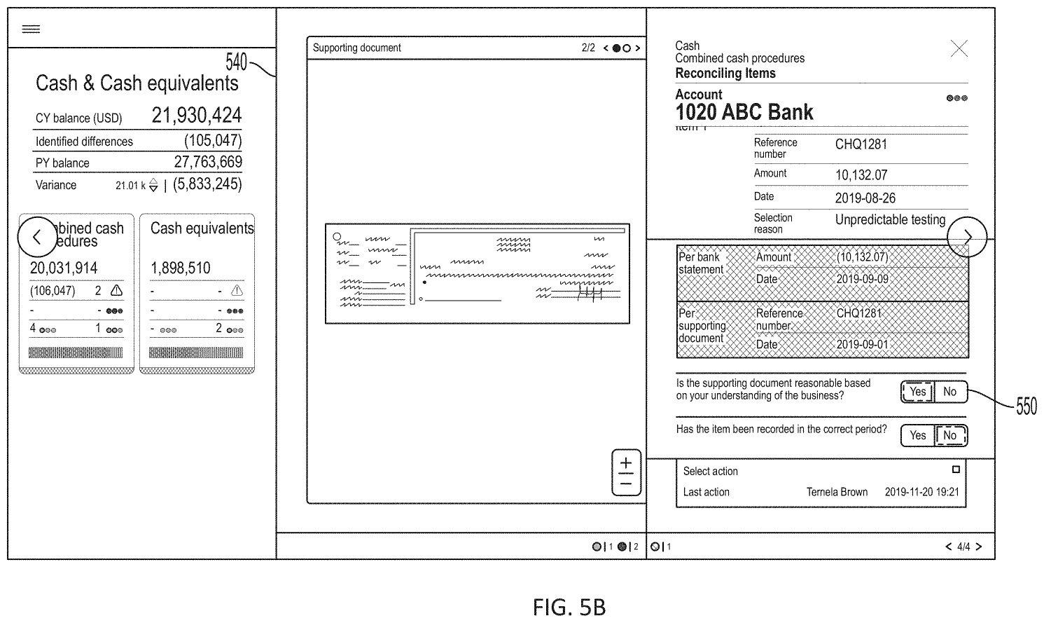

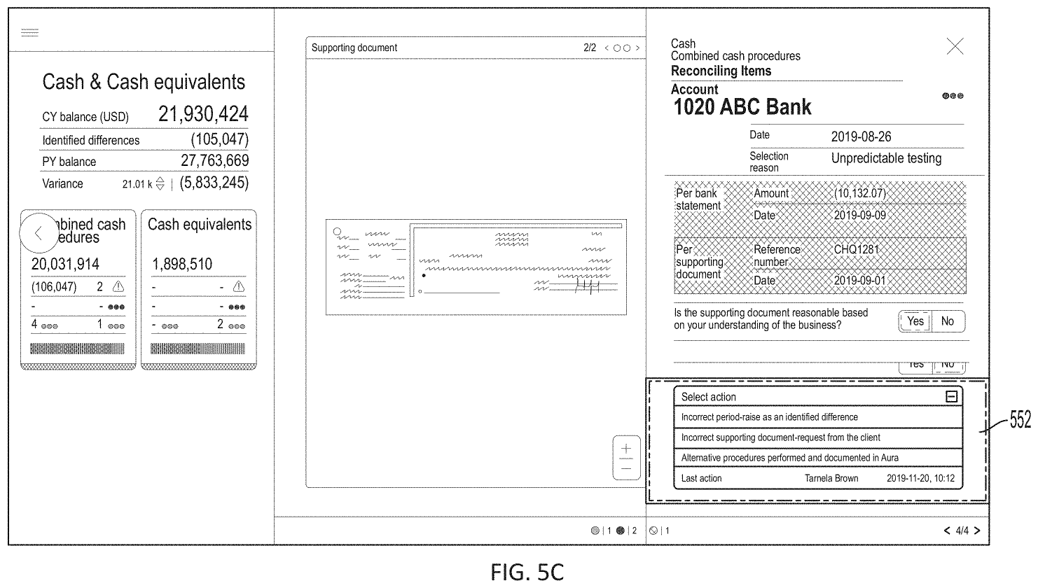

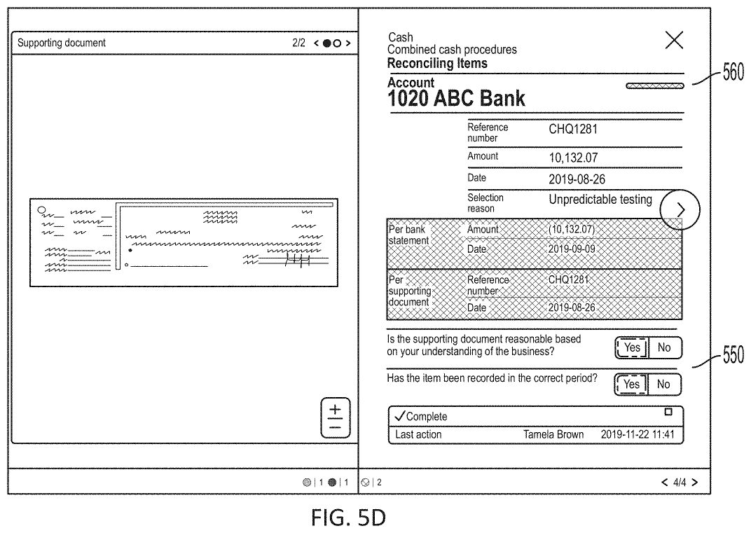

In some embodiments, in response to selecting by a user a user-selectable status icon, verification data may be displayed. In some embodiments, the verification data may be displayed as a pop-up panel, an additional window, or an updated window. The verification data displayed may correspond to the test and bank account information associated with the selected user-selectable status icon. In some embodiments, the verification data may include a list of user-selectable verification items. For example, FIG. 5A shows an example of a list of user-selectable verification items 510. In some embodiments, the verification items may include documents (such as deliverables provided to the additional information module 162) that are used by the corresponding test to verify the corresponding bank account. In response to a first selection of a verification item from the list of user-selectable verification items, additional details of the verification item may be displayed. An example of additional details 520 of a verification item 530 is illustrated in FIG. 5A. The additional details 520 may include a request 570 for a user to provide supporting documents. In some embodiments, the user may provide supporting documents or another user may provide documents. Once the supporting document is detected as a second input, the corresponding user-selectable status icon on the dashboard (such as dashboard 430) and a status of the test on the verification data viewing may be automatically updated based on the second input.

In some embodiments, a third input may include selection of a verification item from the list of user-selectable verification items. In response to the third input, one or more supporting documents associated with the verification item may be displayed. An example of a supporting document 540 associated with a verification item is shown in FIG. 5B. In some embodiments, if relevant, the additional details 510 of a verification item may include one or more actions 550 to be completed by a user. In some embodiments, where relevant, supporting questions may appear that correspond to the verification item. FIGS. 5B-5C show examples of one or more actions 550, 552. In response to detecting a response by a user to the one or more actions 550, a status of the corresponding test may be automatically updated based on the detected response. In some embodiments, the corresponding dashboard (such as dashboard 400) will automatically update the corresponding user-selectable status icon of the dashboard and the corresponding summary (such as 410, 420). In some embodiments, selecting an action may confirm the overall status of the verification item and populates the corresponding dashboard accordingly. In some embodiments, a display of the one or more actions 552 may be expanded according to reason selected. In some embodiments, in response to completing the one or more actions, details concerning the one or more actions may be populated in the display of the one or more actions 552. FIG. 5D shows an example of a status 560 displaying a completed status in response to detecting that the user responded to one or more actions 550.

In some embodiments, the one or more actions to be completed by the user may include whether the supporting document is reasonable based on a user's understanding of the business, entity, or bank account. In some embodiments, the one or more actions to be completed by the user may include whether the supporting document has been recorded correctly. In some embodiments, the one or more actions to be completed by the user may include if further documentation should be considered. In some embodiments, the one or more actions to be completed by the user may include uploading supporting documentation.

In some embodiments, in response to detecting a user's response to the one or more actions, additional actions to be completed by the user may be displayed. For example, FIG. 5C shows additional action 552 in response to a user's response to the one or more actions 550 shown in FIG. 5B. The additional actions such as 552 may include, for example, options for the user to select. The options may include identifying that there is a difference between the bank account information and the supporting documentation, requesting supporting documentation from the client, or determining that alternative procedures should be performed. In some embodiments, as shown in FIG. 5D, answering a first question triggers an additional question to be completed by the user. In some embodiments, if there are no issues, the test may be automatically marked as complete and the status be automatically updated.

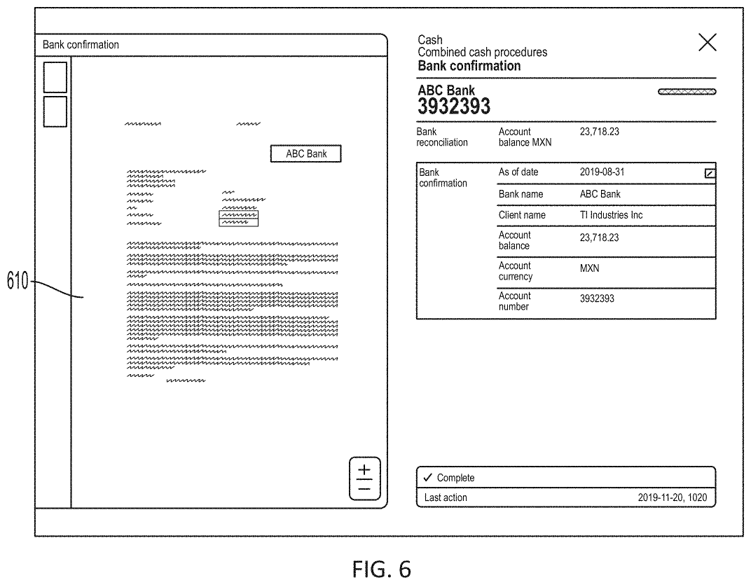

In some embodiments, if bank account information for a first bank account agrees with all of its associated verification items for a first test, then the first test is automatically marked as complete, with a timestamp of the last action. FIG. 6 shows an example of a supporting document 610 (such as supporting document 540) that is determined by a test to agree with its associated bank account information. As shown in the example of FIG. 6, AI may agree the bank confirmation to the information provided by the audit team and the balance per the reconciliation. As shown in the example of FIG. 6, if all items agree, the test may be automatically marked as complete with a timestamp of the last action.

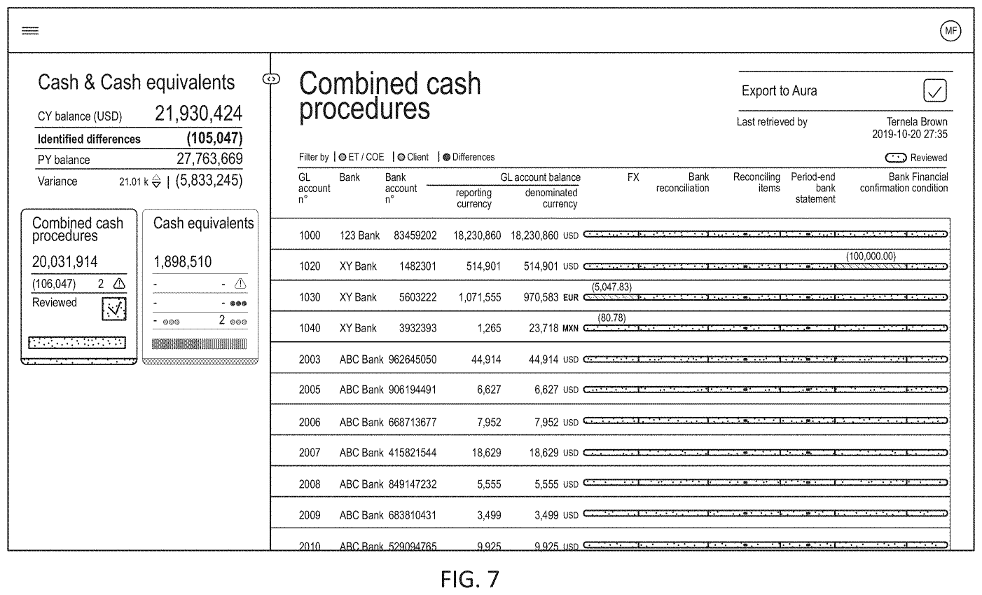

In some embodiments, once a test has been completed, a reviewer of the audit team may review the tests. In some embodiments, once each test that requests review from a user is reviewed, the reviewer may export completed audit files. FIG. 7 shows an example of a cash audit ready that is completed and reviewed, according to some embodiments.

### Tests of the Audit

In some embodiments, the audit may include performing a plurality of audit tests. The tests may be configured to determine whether bank account information agree with verification data associated with the bank account information. In some embodiments, the tests may include assessment of foreign exchange, bank reconciliation, reconciling items, bank confirmation, and financial condition of the bank. Each test of the audit may target assessment of different aspects of a given bank account. The status of each test may be determined based on bank account information and associated verification data, and illustrated via user-selectable status icons (such as icons 480) on the dashboard (such as dashboard 430). In response to selection of a user-selectable status icon of a particular test, a user may be presented with one or more options to review a test which once reviewed may automatically update a status of the audit. In some embodiments, in response to selection of a user-selectable status icon, a viewing of additional information regarding the associated test may be displayed and the viewing may also include a status of the test that matches the selected user-selectable status icon. The user-selectable icons (such as icons 480) and the additional status included in the viewing of additional information may automatically update to illustrate an updated status of each test as the test progresses or as the user responds to one or more actions to progress the test via a GUI display (such as 160, 400).

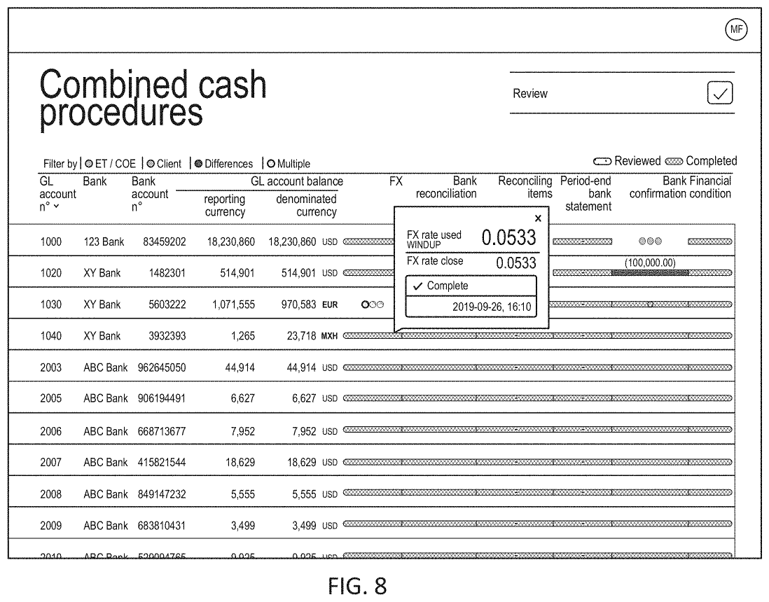

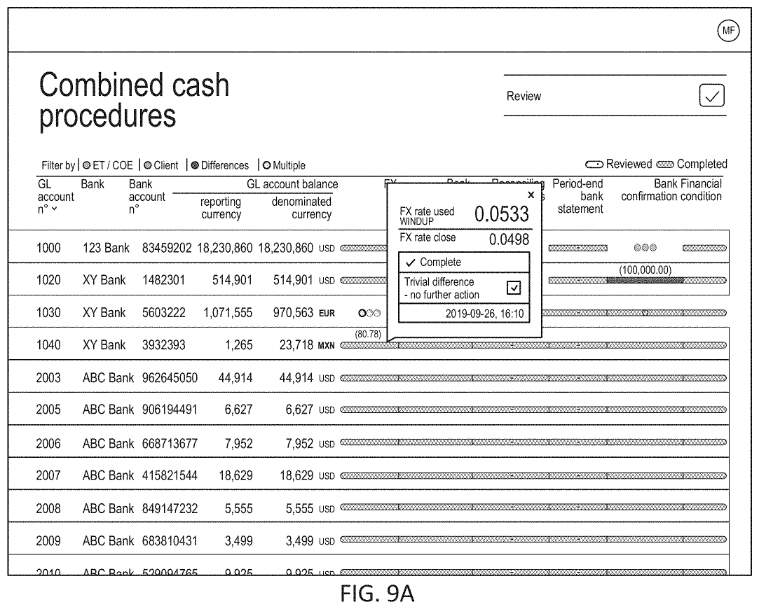

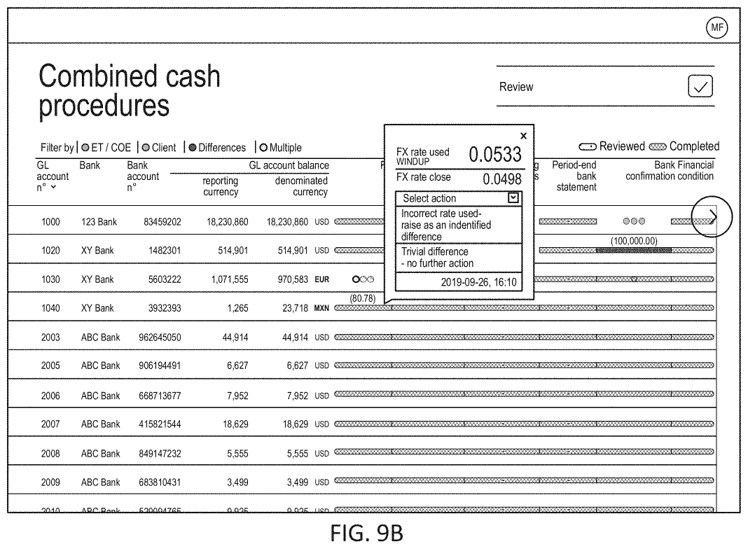

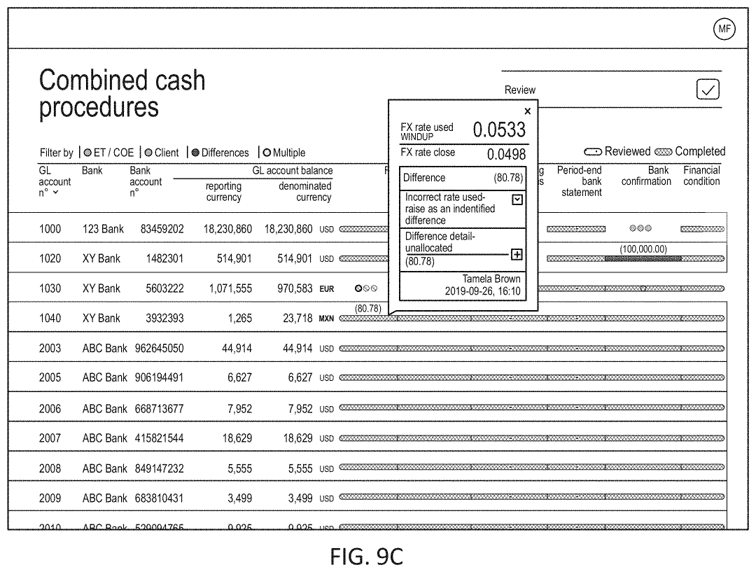

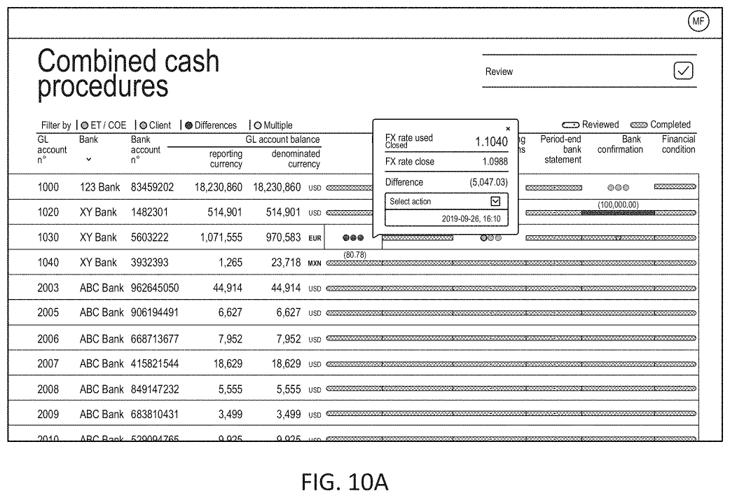

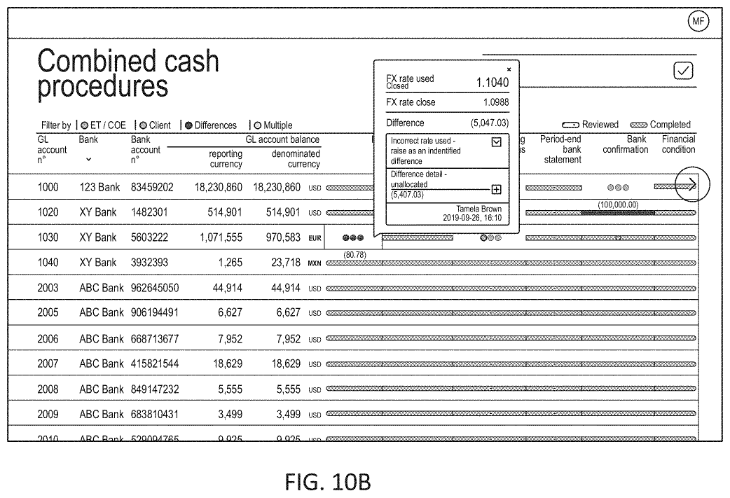

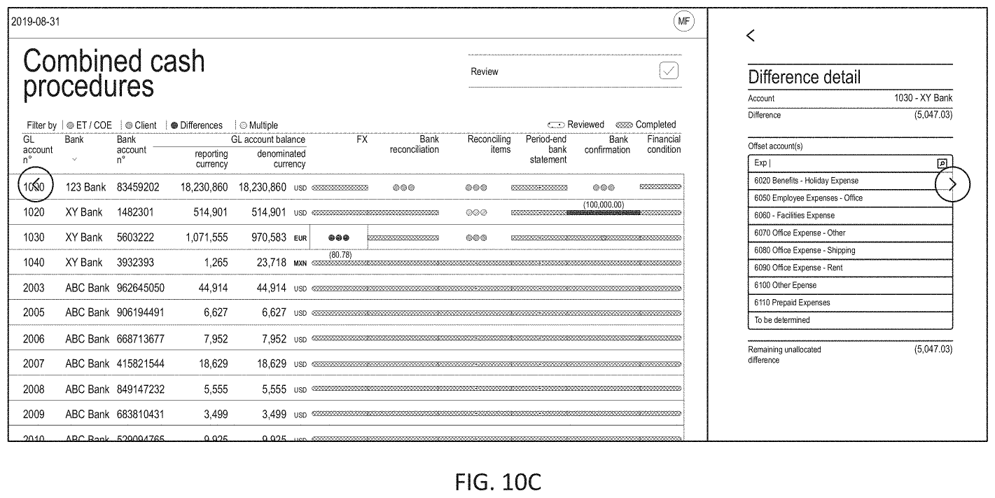

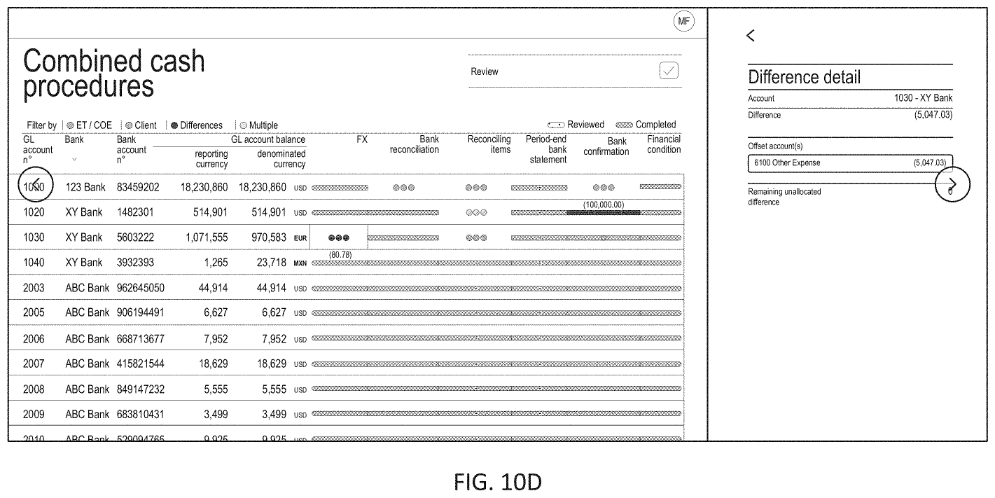

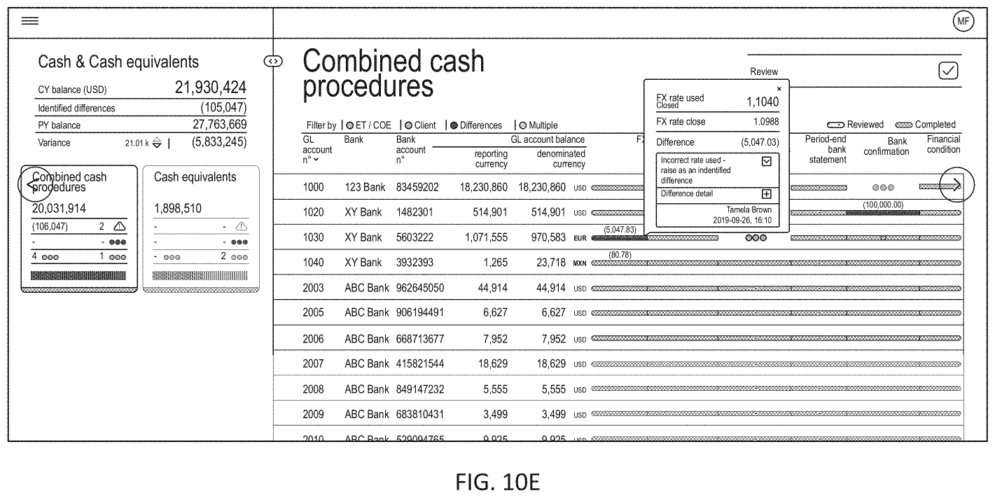

In some embodiments, a foreign exchange test may be configured to determine whether a foreign exchange rate used by the client in a trial balance (such as the trial balance 300) agrees with a foreign exchange rate determined by a third party source. FIGS. 8-10E illustrate examples of a dashboard (such as dashboard 430) in response to a user selection of a user-selectable icon associated with a foreign exchange test, according to some embodiments. In the example of FIG. 8, the foreign exchange test determines that the foreign exchange rate used by the client agrees with the third party source. In some embodiments, the foreign exchange rates may be provided by MIDA and compared to the client calculated rate. If the client foreign exchange rate agrees with the closing MIDA rate, AI may automatically mark the status of the test as complete. In some embodiments, if the reporting currency is the same as the denominated currency, no indication of a discrepancy will appear. In some embodiments, if the reporting currency is different from the denominated currency, clicking on a corresponding status icon will display the difference. In the examples of FIGS. 9A-9C, the foreign exchange test determines that the foreign exchange rate used by the client disagrees with the third party source by a trivial amount. In some embodiments, a trivial amount may be determined based on whether the amount is below a threshold. In some embodiments, if there exists a trivial amount, then a value of the trivial difference may appear in a color indicating a trivial amount. The value of the trivial difference may be displayed above the corresponding user-selectable icon (such as icons 480). In some embodiments, the user may agree the difference is trivial and no further action for the foreign exchange test of the corresponding bank account is requested. In some embodiments, a user reviewing the values associated with the trivial difference may change the designation from trivial to a non-trivial difference as appropriate. In some embodiments, a user may interact with the dashboard display, for example, via pop-up panel, drop-down menus, scrolling menus, expanding menus, to change the designation from trivial to a non-trivial difference. In some embodiments, a user may allocate the non-trivial difference to the relevant GL codes. In the examples of FIGS. 10A-10E, the foreign exchange test determines that the foreign exchange rate used by the client disagrees with the third party source by a non-trivial amount. In some embodiments, a user reviewing the values associated with the non-trivial different may select an offset account to allocate at least part of the non-trivial difference, if appropriate. In some embodiments, when the foreign exchange rate used by the client does not agree with the closing MIDA rate, the difference may be visually illustrated, for example by illustrating a corresponding user-selectable icon have a particular shape and color that corresponds with the difference. In some embodiments, a user reviewing the values associated with the non-trivial different, may select an option describing a reason for the non-trivial difference. For example, the reason may include an incorrect rate was used and that the non-trivial difference is an identified difference, or the reason may include that the non-trivial difference is unallocated. In some embodiments, if a user indicated the non-trivial difference as an identified difference, then an additional display of options may appear to display how the difference should be allocated. In some embodiments, a user reviewing the values associated with the non-trivial different may select that an option that indicates the relevant offset account is unknown and is to be determined. In some embodiments, to select an offset account, a user may type the first three letters to trigger the display of relevant accounts. If the relevant account is unknown, the user may alternatively select “to be determined.” As shown in the example of FIG. 10D, upon user selection of the offset account, the remaining unallocated difference may be calculated. As shown in the example of FIG. 10D, a navigating icon may be used to return to an updated dashboard from the difference detail display. In some embodiments, upon user selection of an offset account or that the offset account is unknown, the associated user-selectable status icon may be updated on the dashboard (such as dashboard 430) and on the corresponding summary (such as summaries 410, 420).

In some embodiments, a bank reconciliation test may assess whether the bank reconciliation to the GL agrees with the associated bank statement, verifies mathematical accuracy, and allows a user to select items for testing. In some embodiments for each account where a reconciliation is expected and received, a bank reconciliation test may be completed to determine whether the GL balance and the balance per the reconciliation to the GL and year-end statement agree. The bank reconciliation may also include verification of mathematical accuracy of the bank reconciliation. In some embodiments, intelligent automate may present the bank reconciliation in a standardized format. If reconciliation is expected, the bank reconciliation test may determine whether the GL balance per reconciliation and the GL balance per trial balance is in agreement. If reconciliation is not expected, the bank reconciliation test may determine whether the GL balance per trial balance and a corresponding bank statement or bank confirmation is in agreement.

In some embodiments, the bank reconciliation test may determine whether an amount per the bank as per the reconciliation and a year-end bank statement (or a bank confirmation if the bank statement has not been provided). In some embodiments, any identified reconciling amount that are on the bank statement and not in the GL may be summarized in the bank reconciliation test. If the identified difference is above a threshold, then the bank reconciliation test may automatically flag the identified difference.

In some embodiments, a user may select items for bank reconciliation. In some embodiments, an item may be selected for bank reconciliation based on risk (such as long outstanding, dishonored/returned, significant reconciling items and unpredictable testing). In some embodiments, the bank reconciliation test may automatically pre-selected if any individual items are above performance materiality. In some embodiments, for all accepted reconciliations, a running total may be presented for both unselected positive and negative reconciling items, with the its associated percentage of performance materiality. In some embodiments, a user may confirm whether the selection process of reconciling items is completed, and confirm whether requests should be sent to the client. In some embodiments, if the total unselected positive or negative reconciling items amount is above performance materiality, the user may be asked to select addition items to have the reconciliation test perform an accept-reject test over the remaining untested population.

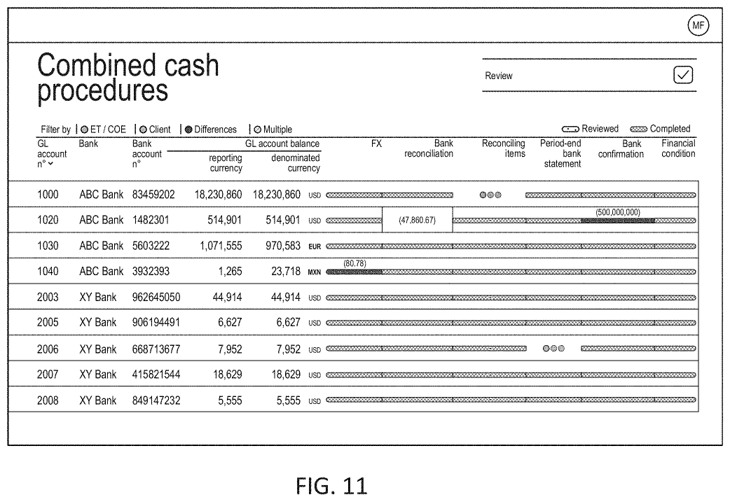

In some embodiments, where no bank reconciliation is expected (per the set-up (such as set-up information 120), the GL balance per the trial balance (such as trial balance 300) may be compared to a third party document (such as a bank statement or bank confirmation). If the balance does not agree to the third party document, the user may request a bank reconciliation on the account associated with the balance that does not agree to the third party document. User-selectable icons (such as icons 480) associated with a bank reconciliation test may illustrate whether or not the bank reconciliation to the GL agrees with the associated bank statement and whether the bank reconciliation includes mathematical inaccuracies. In some embodiments, the user-selectable icons associated with a bank reconciliation test may include a hover selection option. FIG. 11 illustrates an example of the hover selection feature, according to some embodiments. As shown in the example of FIG. 11, hovering over a user-selectable icon shows net reconciling differences. In some embodiments, selecting the user-selectable icon may display additional results of the corresponding test.

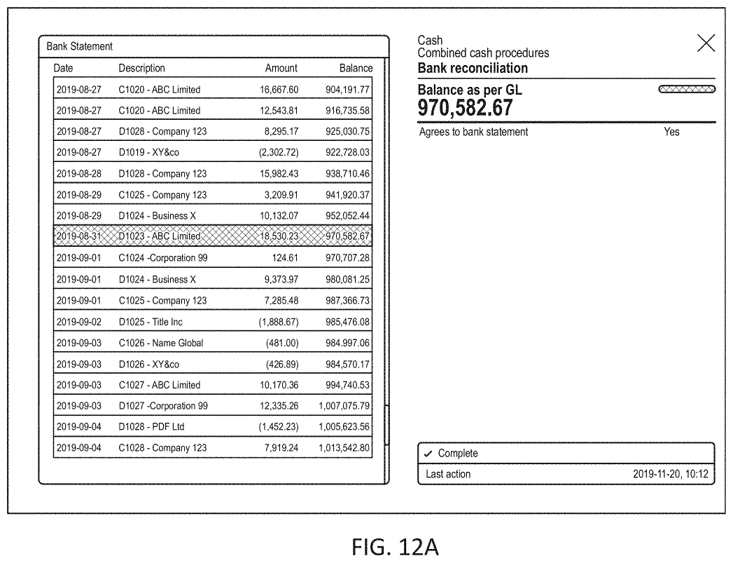

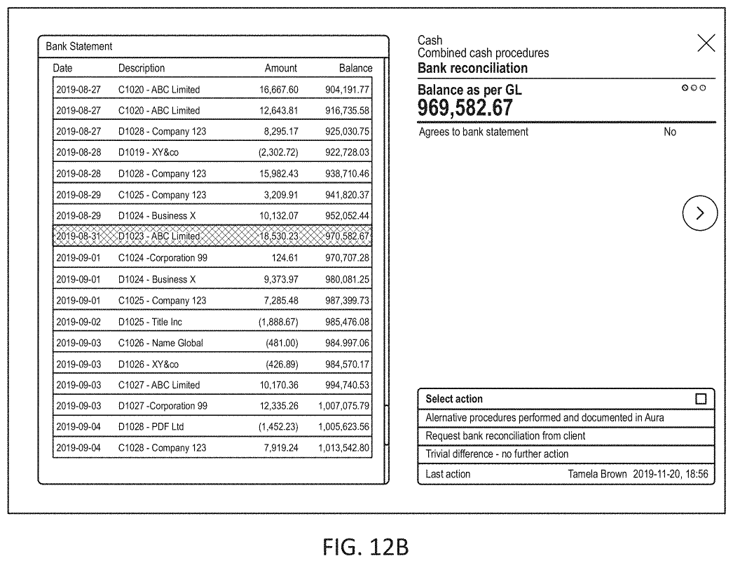

FIGS. 12A and 12B illustrate examples of results of a bank reconciliation test when reconciliation is not expected, according to some embodiments. FIG. 12A shows an example of when GL agrees to the associated bank statement and the test is marked as complete. As shown in the example of FIG. 12A, the bank statements may be shown. In some embodiments, where no bank reconciliation is expected, the GL is automatically agreed to the bank statement. In FIG. 12B shows an example of when GL does not agree to the associated bank statement and thus a pending difference is automatically generated. In some embodiments, when the GL does not agree to the associated bank statement, the GUI display (such as GUI display 160) may display one or more options for a user to respond to the identified disagreement. For example the user may select whether alternative procedure may be performed, whether to request bank reconciliation from the client, or whether the disagreement is trivial.

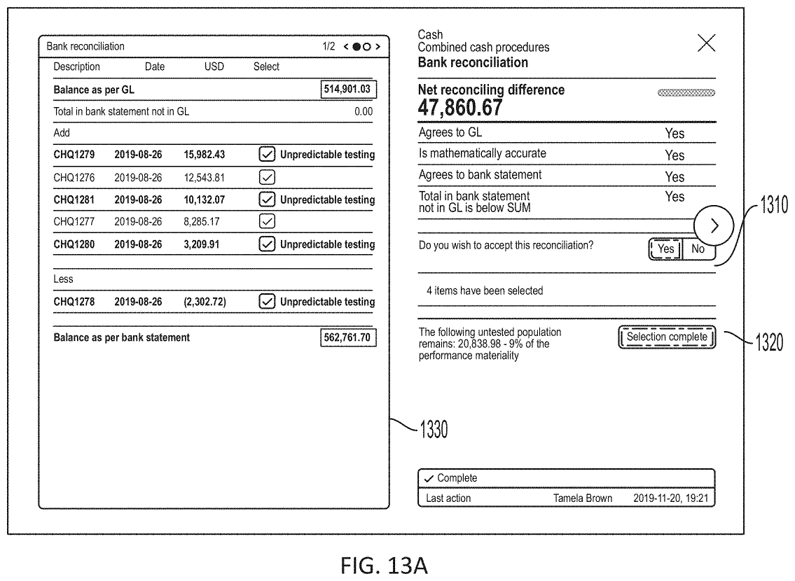

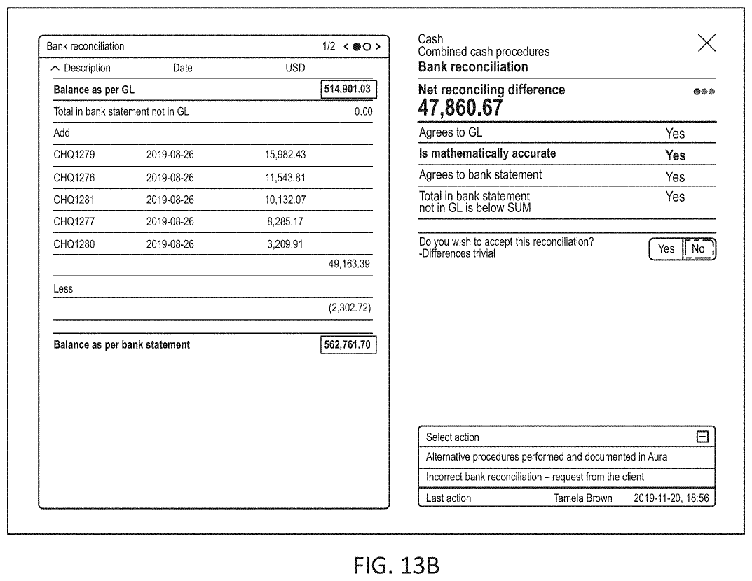

FIG. 13A illustrates an example of results of a bank reconciliation test when reconciliation is expected and no disagreements are identified, according to some embodiments. In some embodiments, when reconciliation is expected and no disagreements are identified, the status of the test may be automatically updated and marked as complete. In some embodiments, the bank reconciliation test may rely on user selection to finalize the bank reconciliation test. In some embodiments, in response to selecting a user-selectable icon (such as 480) corresponding to a bank reconciliation test, the GUI display (such as GUI display 160) may be configured to display a series of action items to be completed by a user. For example, a first action item 1310 to be completed by a user may include a determination of whether the bank reconciliation should be accepted for testing. In some embodiments, in response to detecting that a user accepted the bank reconciliation, a second action item 1320 to be completed by the user may be displayed. In some embodiments, the bank reconciliation test may configured to display a user-selectable list of accounts expected to reconcile. In some embodiments, in response to detecting that a user selection from the list of accounts expected to reconcile, the reconciliation test may display one or more options 1330 that describe reasons for a user selection. In some embodiments, the user may select an option for each account to progress the bank reconciliation test. The user-selectable status icons of the bank reconciliation test may be displayed and updated based on the user's response to the action items.

FIG. 13B illustrates an example of results of a bank reconciliation test when reconciliation is expected and a disagreement is identified, according to some embodiments. As shown in the example of FIG. 13B, identified reconciling amounts (amounts included on the bank statement and no in the GL) may be shown as a separate line item. In some embodiments, if the total is above a threshold, then the amount may be designated as an identified difference. In some embodiments, if the bank reconciliation test identifies a disagreement, the reconciliation test may request, from a user, whether or not the reconciliation having a disagreement should be accepted. In response to a user selection that the reconciliation should not be accepted, the user may select whether alternative procedures should be performed or that reconciliation is incorrect.

In some embodiments, a reconciling item test may compare selected reconciling items (selected during corresponding bank reconciliation test) to a bank statement and accounting records, if applicable. In some embodiments, the reconciling items may be matched against associated post year-end bank statements.

In some embodiments, if the reconciling item amount is not found in the post year-end bank statement, then the user may be requested to select a sample item on the bank statement. If the reconciling item amount is not found in the post year-end bank statement, then the user may select an option to request further supporting documents for the reconciling item.

In some embodiments, if the reconciling item amount is found, then a user may select whether or not further supporting documentation should be provided for the test. In some embodiments, in response to the reconciling items test detecting a user selection indicating that no further supporting documents should be considered, then a user-selectable status of the reconciling items test may be automatically updated to indicate the test is complete. In some embodiments, in response to the reconciling items test detecting a user selection indicating that further supporting documents should be considered, then the reconciling items test may automatically request for further supporting documentation.

In some embodiments, if the reconciling item amount is found, but does not match to a corresponding bank statement of accounting records, then the user may select that further supporting documentation should be considered. In response to detecting that further supporting documentation is provided, the reconciling item test may display via a GUI display (such as 160, 400) one or more actions to be completed by a user. The one or more actions may include actions such as recording the reference, recording the date, and determining whether the supporting documentation is reasonable support for reconciling items. In some embodiments, in response to detecting a user selection that the supporting documentation is reasonable, a status of the reconciling item test may be automatically updated to indicate the test is complete without disagreements. In some embodiments, in response to detecting a user selection that the supporting documentation is not reasonable, a status of the reconciling item test may be automatically updated to indicate the test is complete with disagreements. A user may request additional supporting documents in the evident the supporting documentation provided is not reasonable.

In some embodiments, items may be target tested or accept-reject tested. Target testing may include selecting one or more items for testing based on a characteristic, rather than selecting one or more items “randomly” using audit sampling. Accept-reject testing may include selecting one or more items to test for a characteristic to determine whether to accept or reject that an objective of the test is satisfied by the one or more items based on details of the one or more items. In some embodiments, if an error occurs on an item that was target tested, this will result in an associated user-selectable status icon (such as icons 480) displaying a shape to indicate that the test is pending and may include a disagreement. In such cases, a user may designate that the error is a non-trivial difference, is a trivial difference, or that alternative procedures should be performed. In some embodiments, if an error occurs on an item that was accept-reject tested, then the reconciling item test will automatically default to select that alternative procedures should be performed.

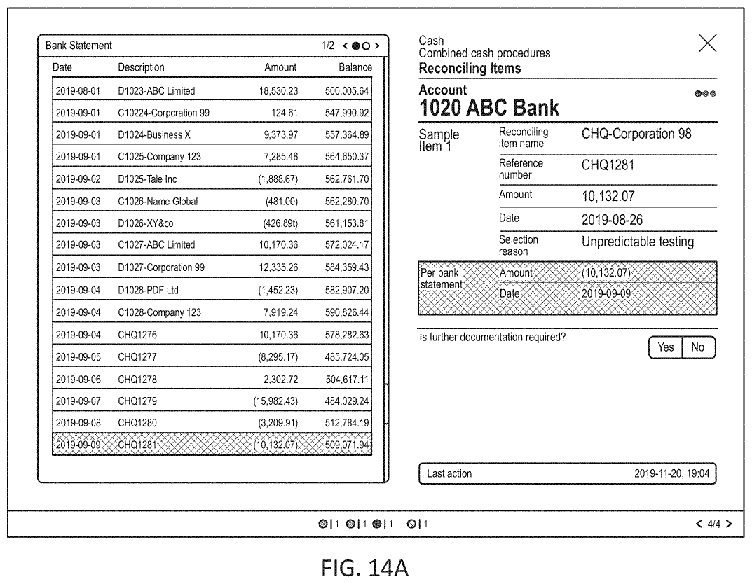

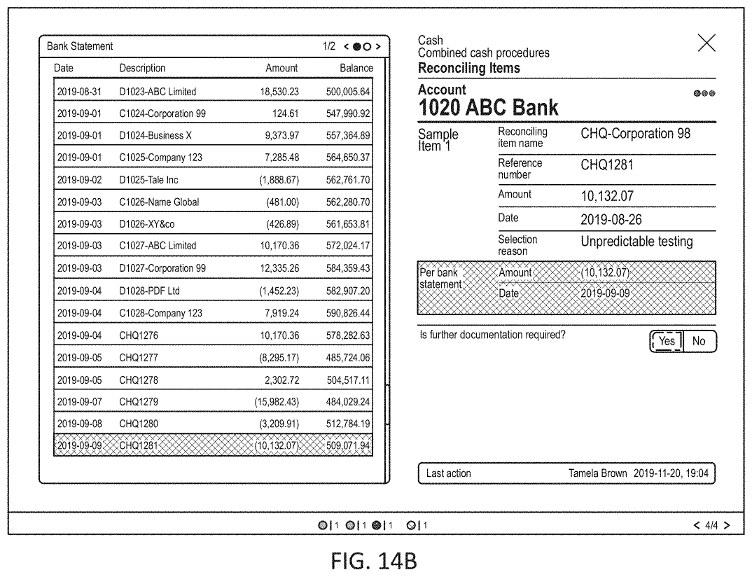

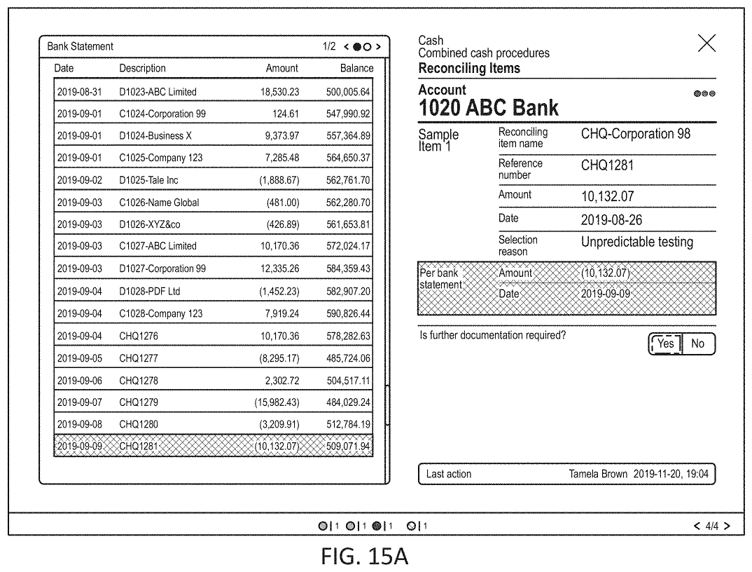

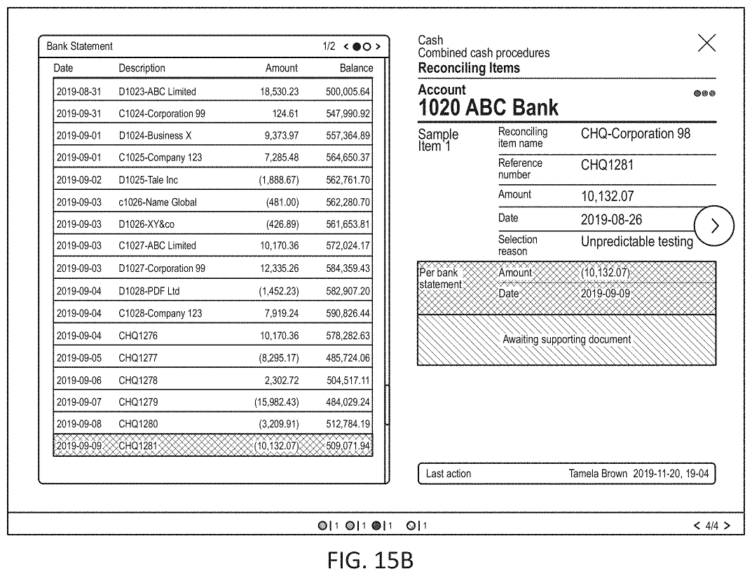

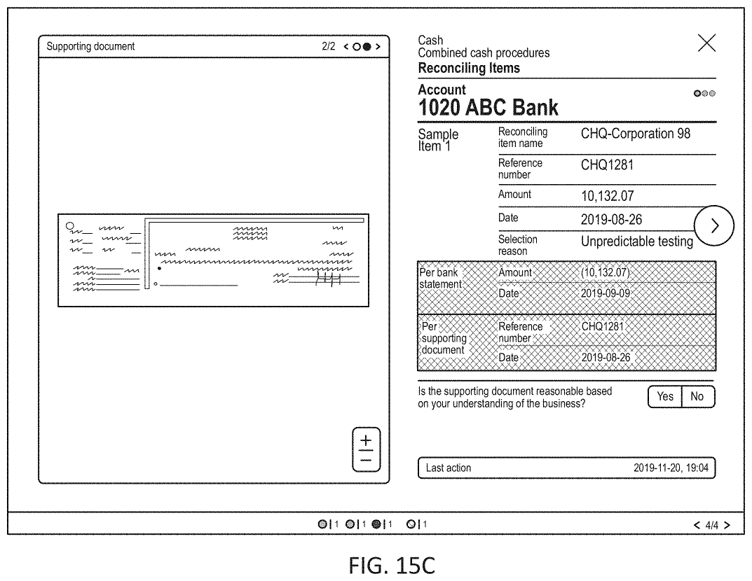

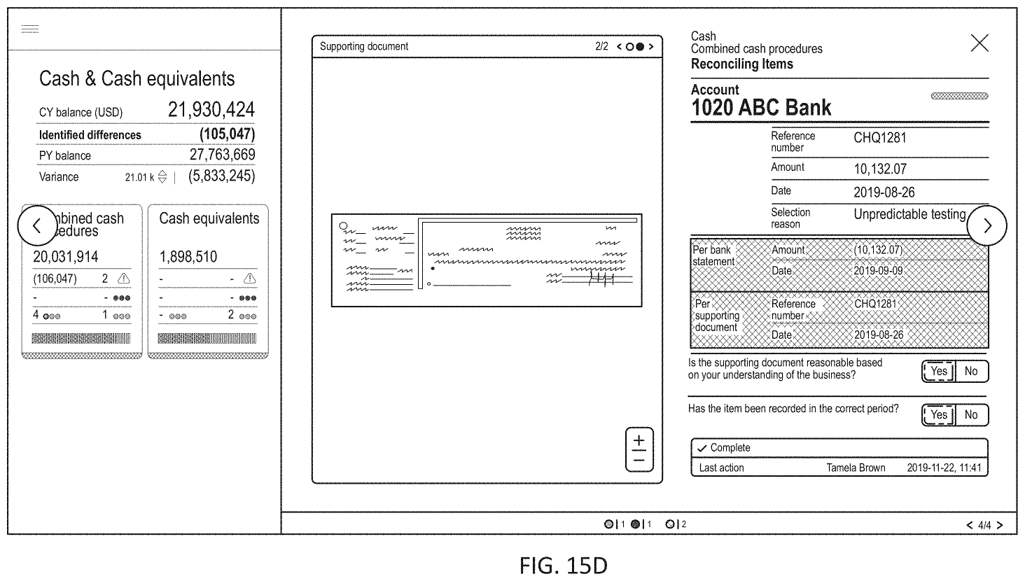

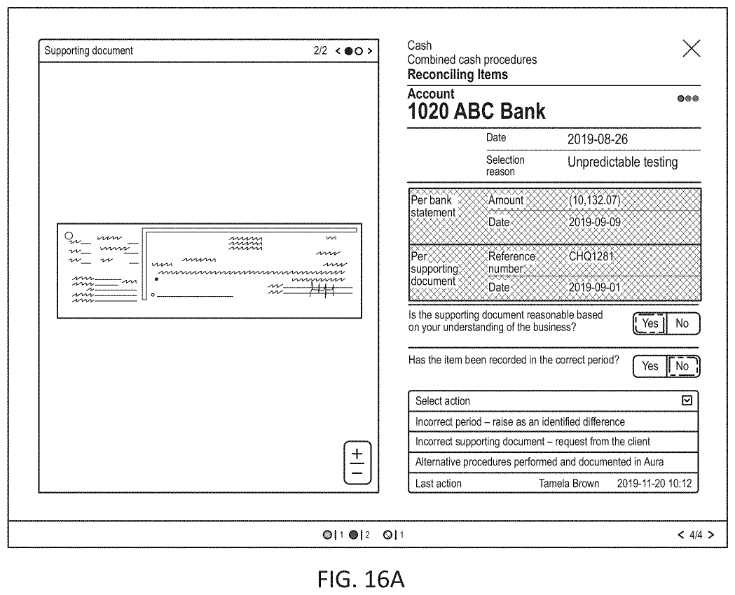

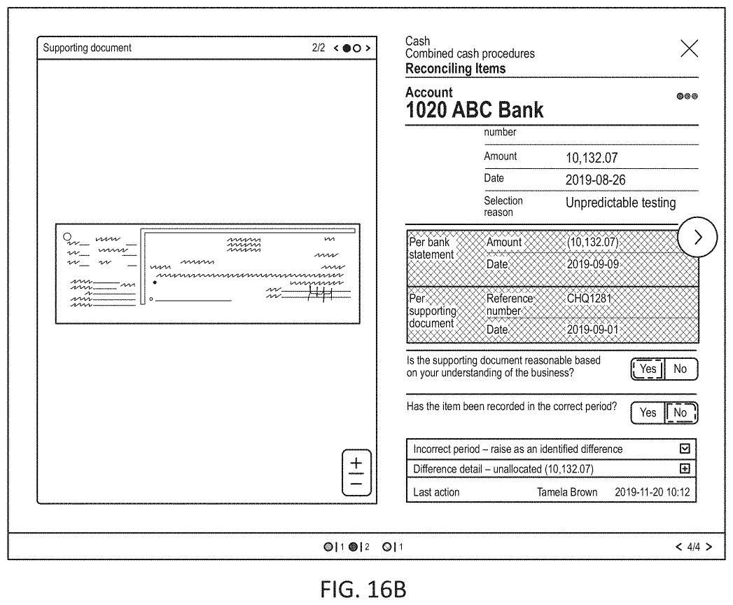

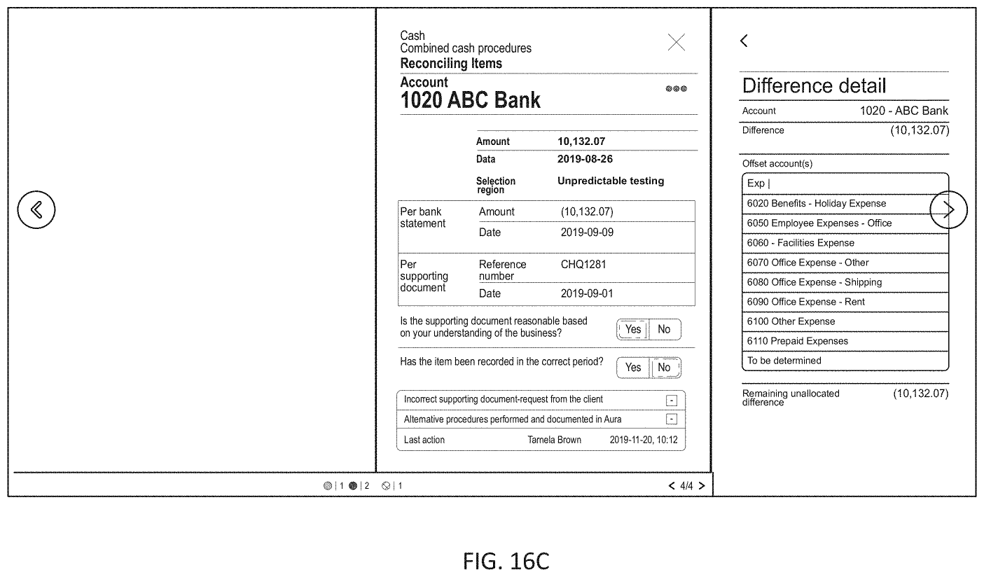

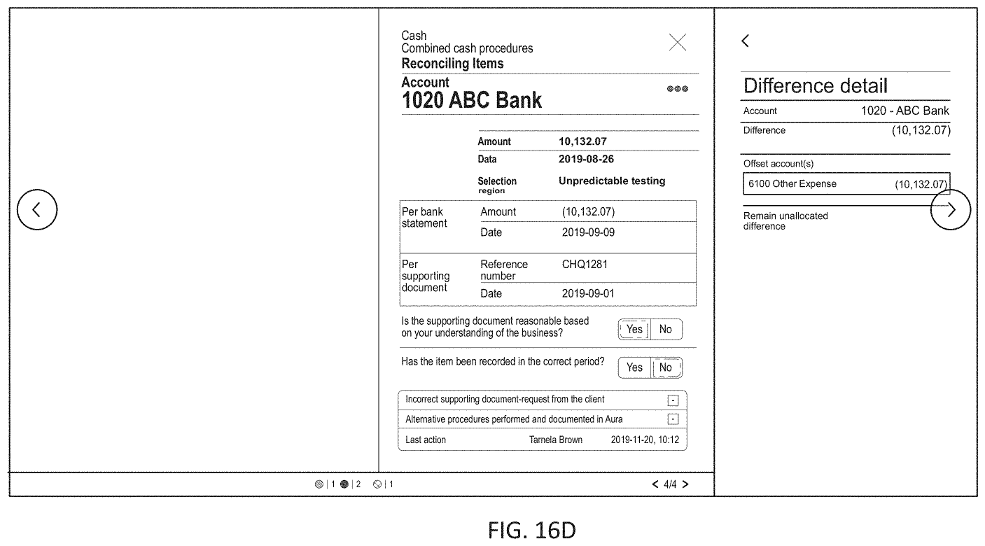

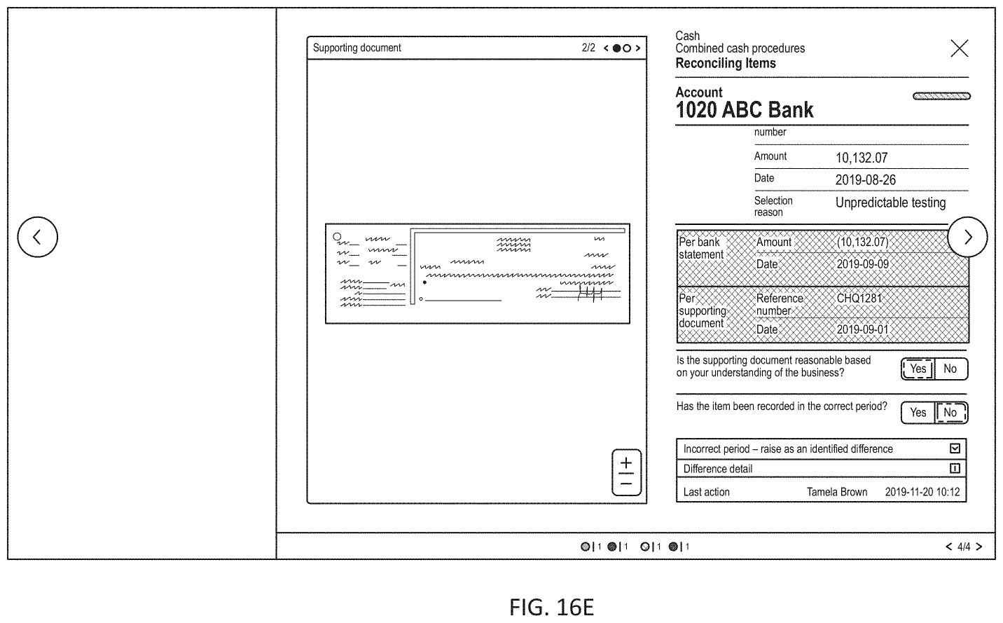

FIGS. 14A and 14B illustrate examples of results of a reconciling item tests when no disagreements are identified and no further documentation should be considered, according to some embodiments. As shown in the example of FIG. 14A, a user may select if additional documentation should be taken into consideration. In some embodiments, upon selection that additional documentation should be taken into consideration, may trigger a request for the additional documentation. FIGS. 15A-15D illustrate examples of results of a reconciling item tests when no disagreements are identified and further documentation should be considered, according to some embodiments. As shown in the example of FIG. 15A, a user may select if additional documentation should be taken into consideration. In some embodiments, upon selection that additional documentation should be taken into consideration, may trigger a request for the additional documentation. As shown in FIG. 15B, upon triggering a request for the additional documentation, a display may be updated informing the user that additional documentation has been requested and the corresponding status on the dashboard may be updated accordingly. As shown in the example of FIG. 15C, once additional documentation is provided, requests for a user to record identifying information (such as recording the reference and date) may be generated. In some embodiments, the user may be designate whether the additional documentation is reasonable support for the reconciling item. As shown in the example of FIG. 15D, in response to the user recording the identifying information and the indicating that the additional documentation is reasonable support for the reconciling item, the test is complete and a status of the test may be automatically updated accordingly. FIGS. 16A-16E illustrate examples of results of a reconciling item test when a difference is identified, according to some embodiments. As shown in the example of FIG. 16A, in response to a user selecting that there exists an error in the identifying information, then additional actions are displayed to the user. As shown in FIG. 16B, one of the additional actions may include designating the error as an incorrect period. In some embodiments, in response to such a designation, a difference detail may be displayed in which the user may provide more details (such as providing a relevant offset account) regarding the error. In some embodiments, to select an offset account, a user may type the first three letters in the difference detail display to trigger the display of relevant accounts. If the relevant account is unknown, the user may alternatively select “to be determined.” As shown in the example of FIG. 16D, upon user selection of the offset account, the remaining unallocated difference may be calculated. As shown in the example of FIG. 16D, a navigating icon may be used to return to an updated dashboard from the difference detail display. In some embodiments, in response to the user providing more details (such as providing a relevant offset account) regarding the error, the associated user-selectable status icon may be updated on the dashboard (such as dashboard 430) and on the corresponding summary (such as summaries 410, 420).

In some embodiments, a bank confirmation test may include comparing a bank confirmation to an associated GL, account number, account balance, and account currency. In some embodiments, upon receipt of a bank confirmation, the bank confirmation may be read by machine learning algorithms and confirmation fields may be matched to the balance per the bank reconciliation provided by the client (or directly to the GL is no reconciliation is expected). In some embodiments, any field that does not match or cannot be read by the algorithms may be identified as a difference and recommended to be reviewed by a human auditor. The human interface with the results of the algorithms may permit either corrections through editing or may permit documentation of the difference.

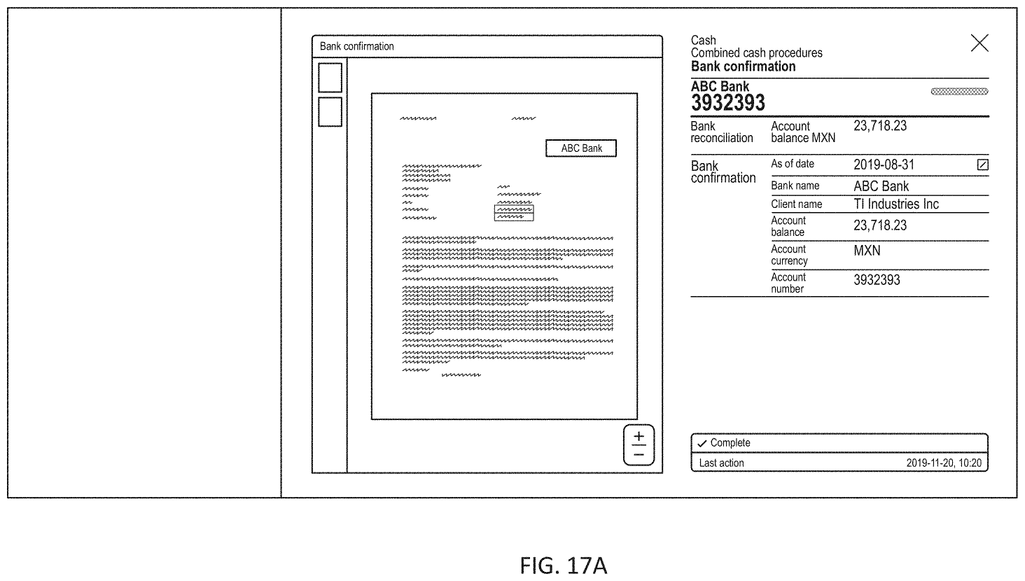

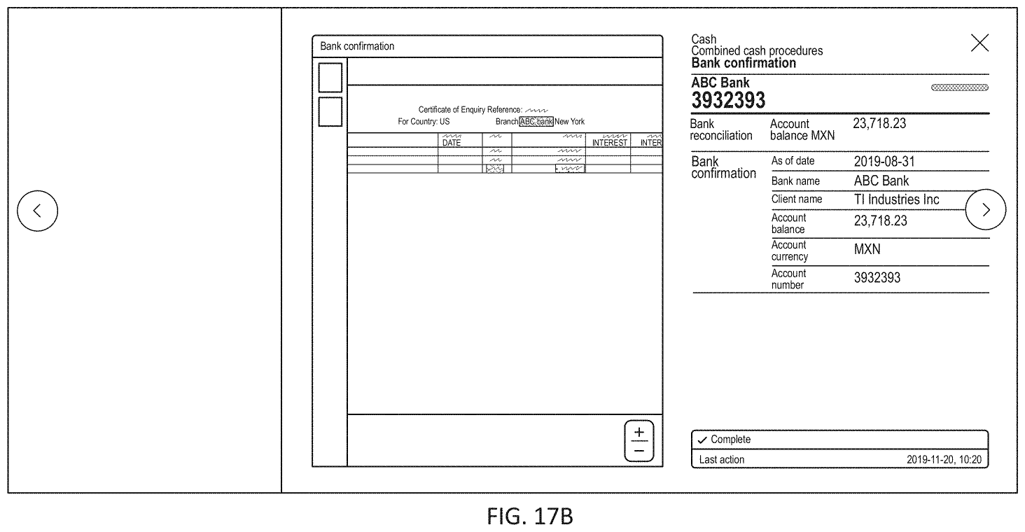

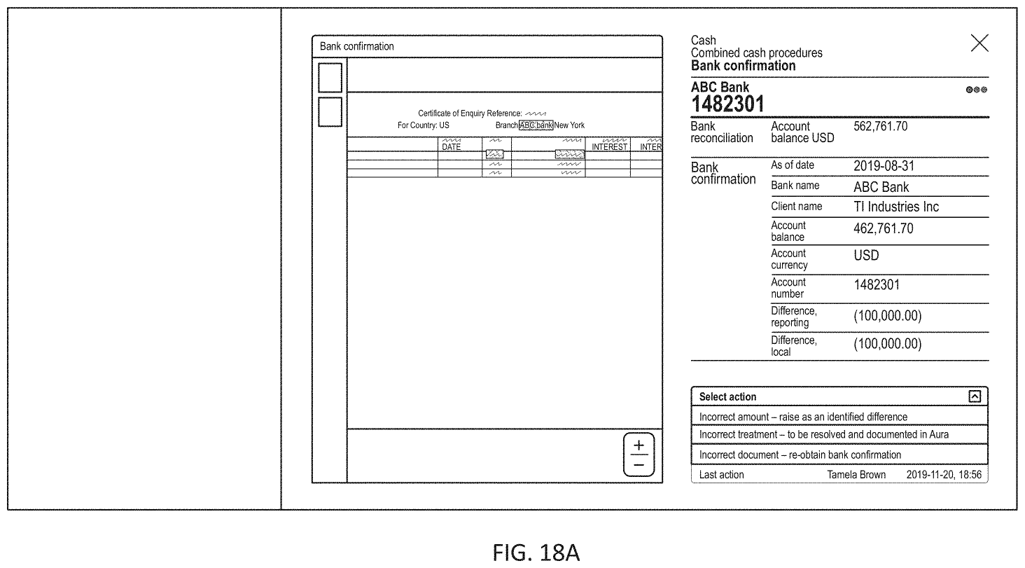

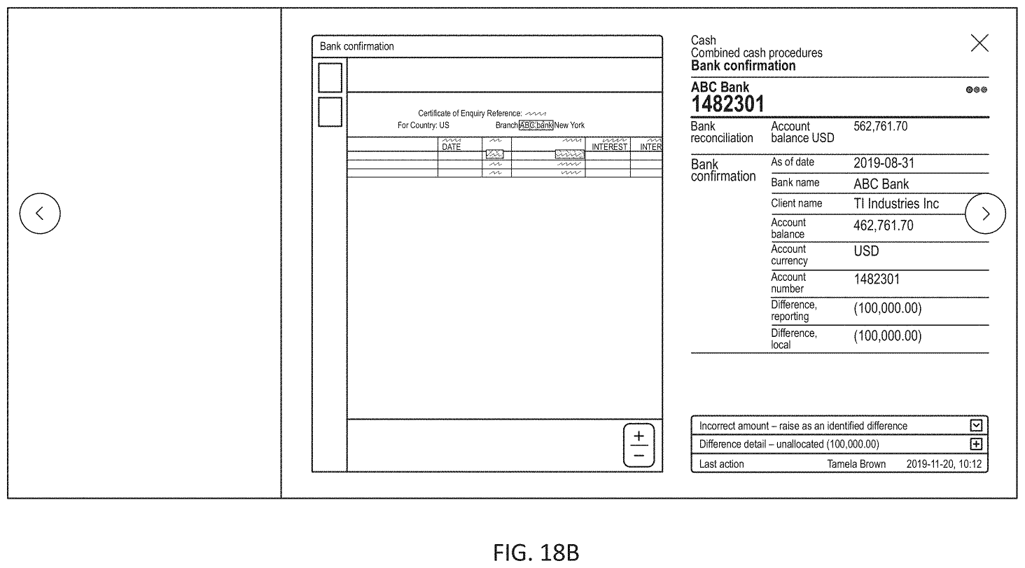

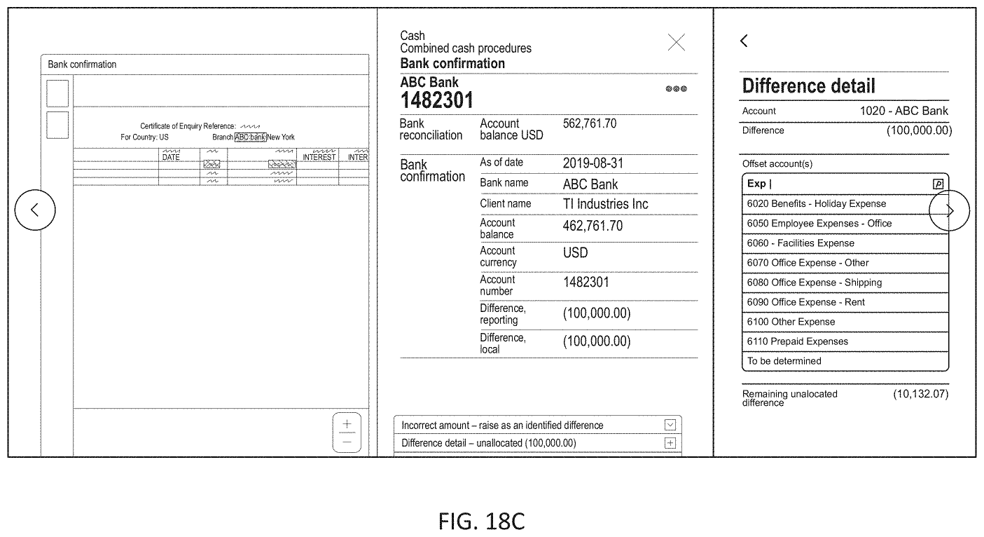

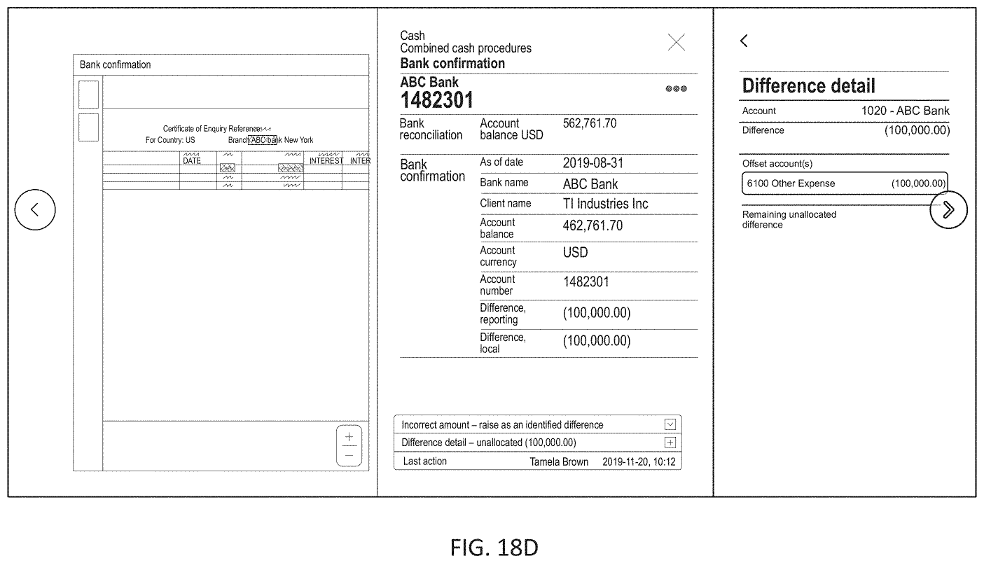

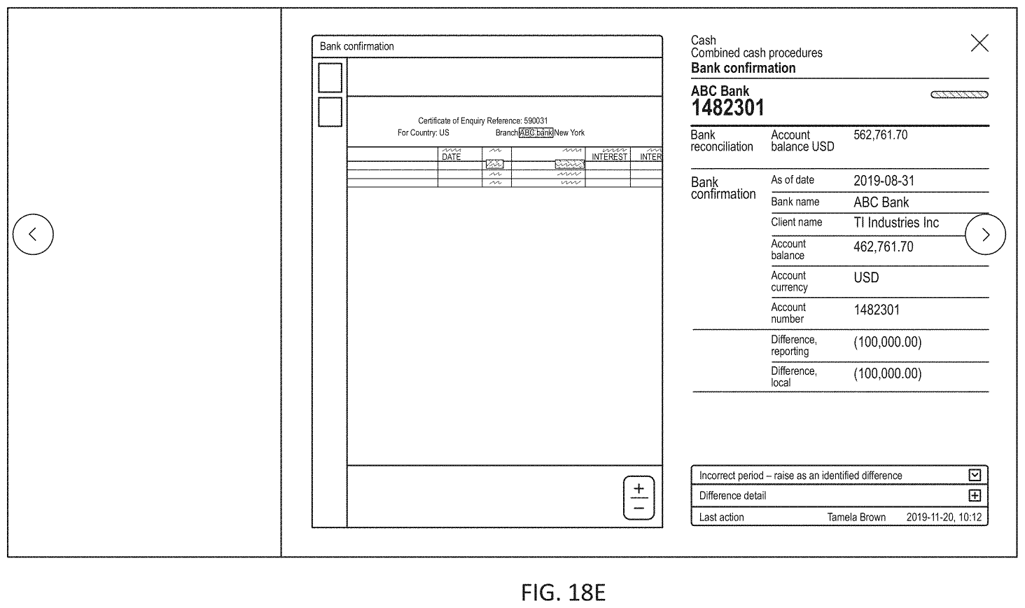

FIGS. 17A and 17B illustrate examples of results of a bank confirmation test that all fields of the bank confirmation match an associated GL, account number, account balance, and account currency, according to some embodiments. In some embodiments, AI may agree the bank confirmation to the information provided by the audit team and the balances per the reconciliation. In some embodiments, items that have been agreed may be highlighted in a color that indicates agreement. In some embodiments, items having corresponding information may be highlighted in a color difference from the color that indicated agreement. If all items agree, the test may be marked as complete with a timestamp of the last action. In some embodiments, clicking the thumbnails shown in FIGS. 17A and 17B opens up a relevant page. In the example of FIG. 17B, selecting a field in the right-hand panel highlights the item in the document display. In some embodiments, if the item selected in the right-hand panel is on a subsequent page of the document, the document display may be automatically updated to display the subsequent page. FIGS. 18A-18E illustrate examples of a bank confirmation test that a difference between the bank confirmation and an associated GL, account number, account balance, or account currency has been identified, according to some embodiments. As shown in the example of FIG. 18A, if the bank confirmation does not agree with the GL account line item, the difference is highlighted as a potential difference. The user may review the potential difference and may be presented with an option to select an action. The action may be for example, that the potential difference is an incorrect amount, incorrect treatment, or an incorrect document. In some embodiments, when an incorrect amount has been selected, then a difference detail display may be generated in which a user may allocate an offset account. In some embodiments, to select an offset account, a user may type the first three letters in the difference detail display to trigger the display of relevant accounts. If the relevant account is unknown, the user may alternatively select “to be determined.” As shown in the example of FIG. 18D, upon user selection of the offset account, the remaining unallocated difference may be calculated. As shown in the example of FIG. 18D, a navigating icon may be used to return to an updated dashboard from the difference detail display. In some embodiments, in response to entering the identified difference, the associated user-selectable status icon may be updated on the dashboard (such as dashboard 430) and on the corresponding summary (such as summaries 410, 420).

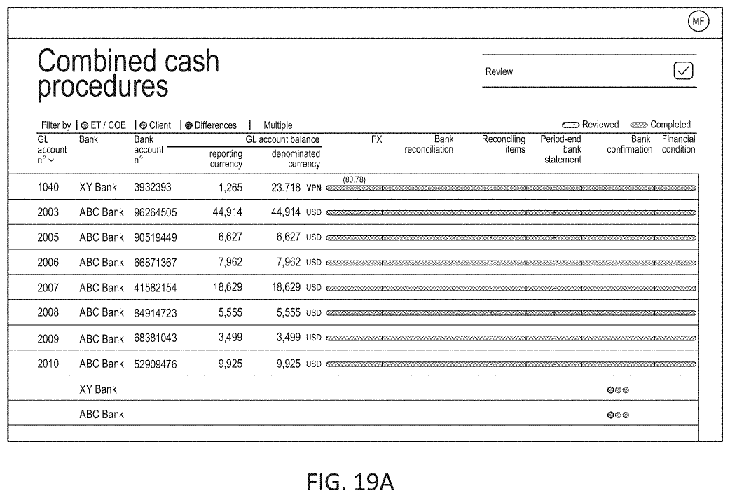

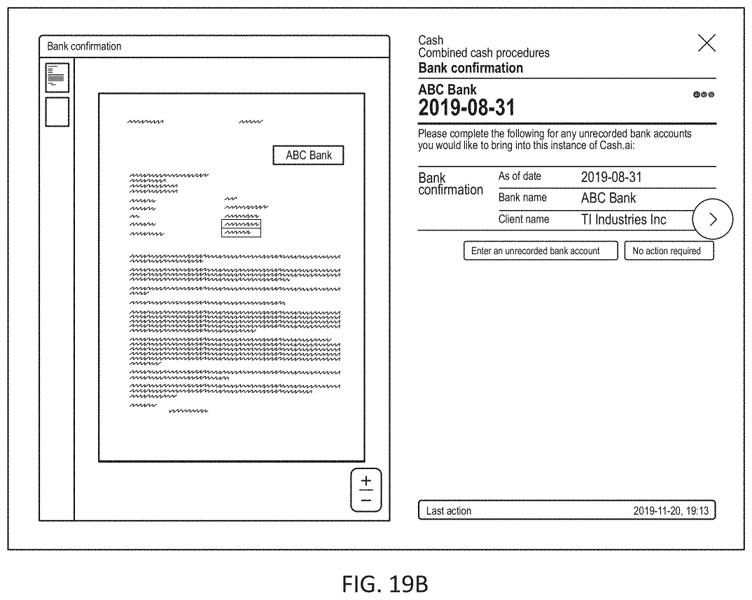

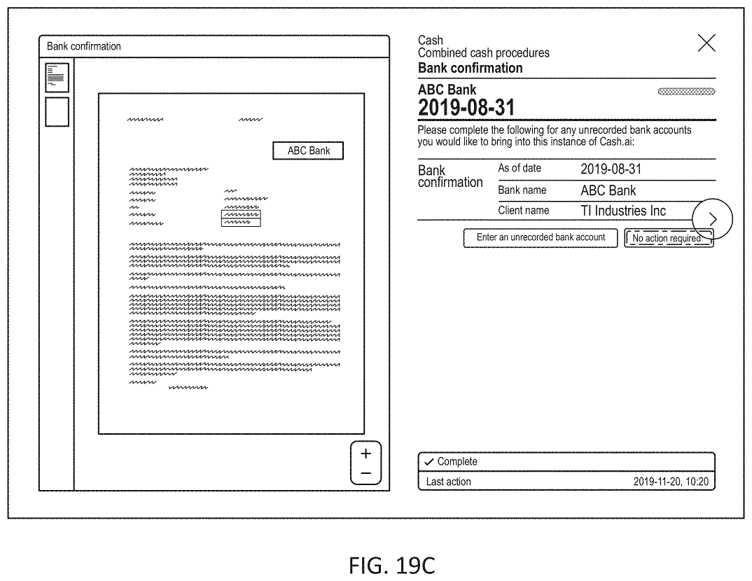

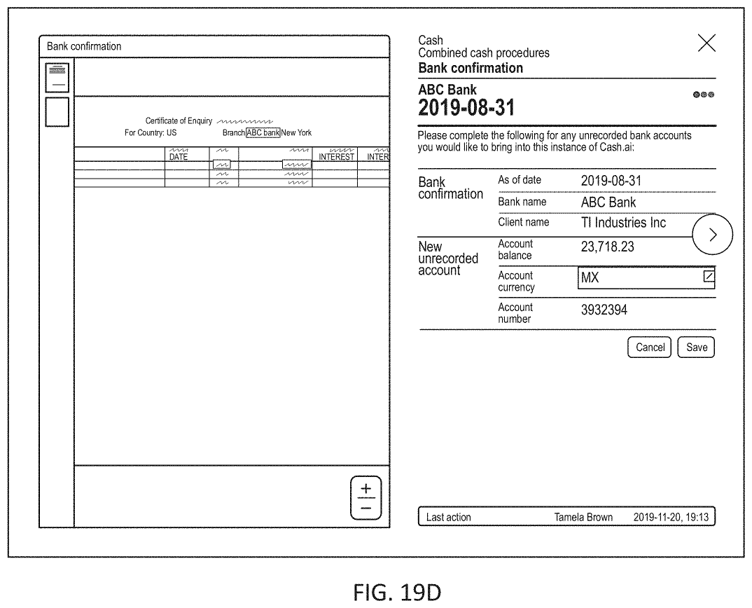

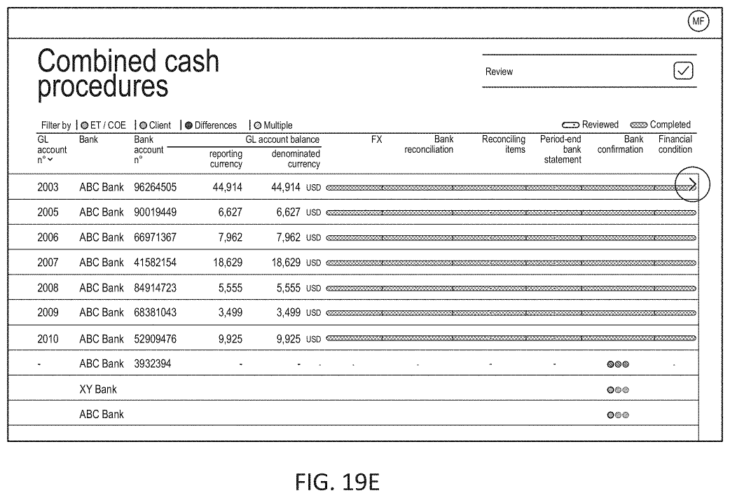

In some embodiments, additional bank accounts may be added to be included in the bank confirmation test. In some embodiments, a user-selectable icon (such as icons 480) may illustrate that a bank account is included in the bank confirmation is not listed on the dashboard (such as dashboard 430). A user may select the user-selectable icon to view information regarding the undocumented bank account. In some embodiments, a user may choose to add the unrecorded bank account or conclude that no additional action in this regard should be completed. In response to user selection that no additional action should be completed, then a status of the bank confirmation test may automatically be updated to indicate the test as complete. In response to user selection that additional action should be completed, then the user may record the unrecorded bank account by manually adding an associated account balance, currency, and number from the bank confirmation. In response to detecting that the user recorded an initially unrecorded bank account, then the user-selectable status icon associated with the bank confirmation test may be automatically updated to conclude an identified difference. FIGS. 19A-19E illustrate examples of adding additional bank accounts to a bank confirmation test, according to some embodiments. As shown in the example of FIG. 19A, a color and a shape of a user-selectable status icon may be used to indicate, where applicable, that a bank account was included in the bank confirmation, but not listed on the dashboard. As shown in the example of FIG. 19B, if a bank account was included in the bank confirmation but not listed on the dashboard, an action may be selected by a user to either add the unrecorded bank account or conclude that no action is needed. As shown in the example of FIG. 19C, if no action is needed, then the status of the test is marked as complete. As shown in the example of FIG. 19D, if an action to add the unrecorded bank account is selected by a user, the user may manually add the account balance, currency, and the number from the bank confirmation. As shown in the example of FIG. 19E, the dashboard may be updated with a bank account that has been recorded by a user and an action to conclude on the identified difference.

In some embodiments, a financial conditions test may verify whether a credit rating of a bank is above or below investment grade. In some embodiments, details of the bank may be obtained from the set-up information (such as set-up information 120). A credit rating for the bank may be obtained from a third party source (such as Standard & Poor's corporate credit). In some embodiments, the financial condition test may determine if the credit rating is above or below a first threshold. If it is determined that the credit rating is above the first threshold, then a user-selectable status icon (such as icons 480) associated with the financial conditions test may be marked as complete and the credit rating may be displayed via the GUI display (such as display 160, 400). If it is determined that the credit rating is below the first threshold and a balance held with that financial institution from all positive bank accounts is above a second threshold, then a user-selectable status icon (such as icons 480) associated with the financial condition test may be automatically updated to show the test as complete, includes an identified difference, and further work should be done.

In some embodiments, if it is determined that the credit rating is below the first threshold and a balance held with that financial institution from all positive bank accounts is below a second threshold, then a user-selectable status icon (such as icons 480) associated with the financial condition test may be automatically updated to show the test as pending. In the pending state, a user may select via the GUI display that alternative procedures should be performed. In response to detecting a user selection that alternative procedures should be performed, then the user-selectable status icon may be updated to illustrate that the test is complete and includes an identified difference.

In some embodiments, for each account where the balance is positive, the financial condition rating of the relevant financial institution may be provided to the audit team to help determine whether further work should be done to address a risk of impairment.

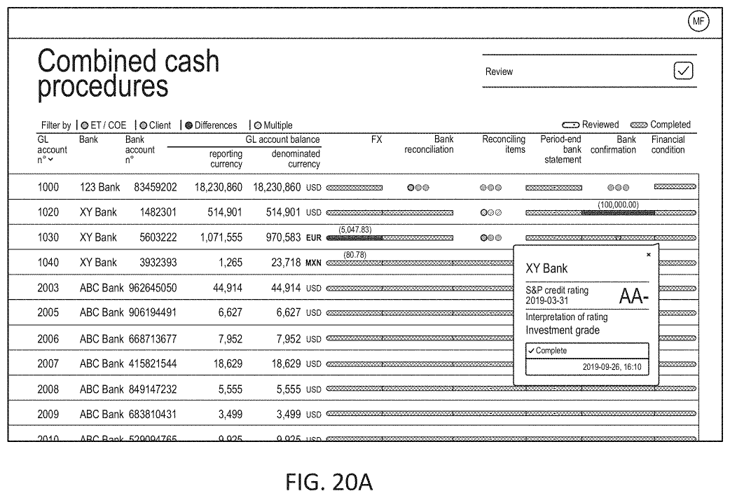

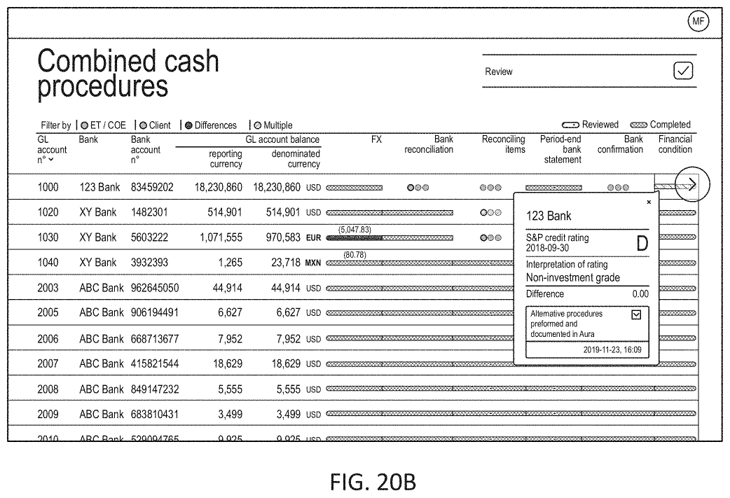

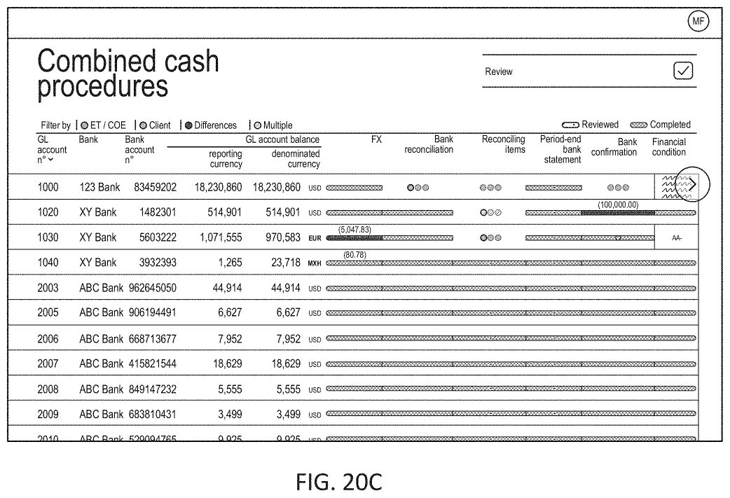

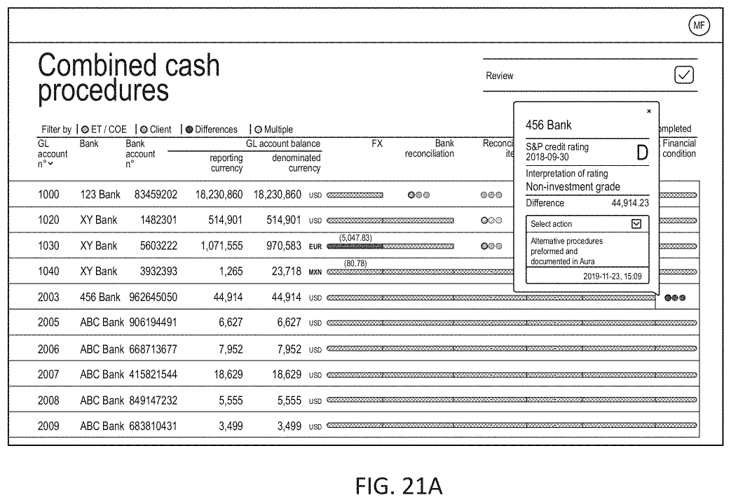

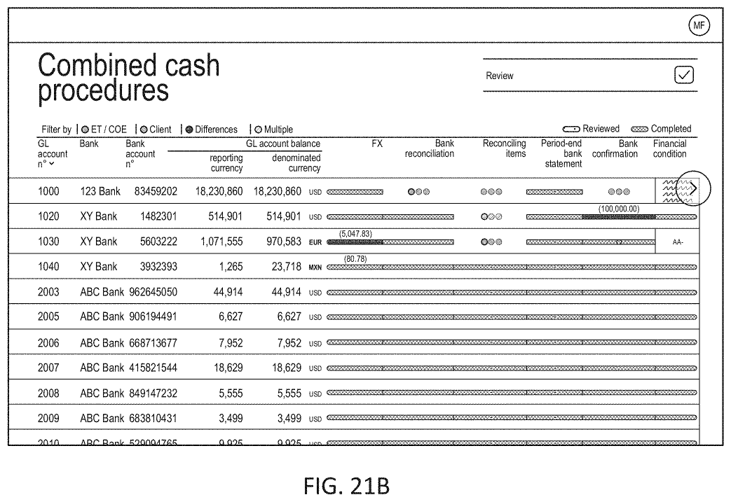

FIGS. 20A-20C illustrate examples of results of a financial condition test, according to some embodiments. FIG. 20A shows an example result of a financial condition test that indicates the credit rating is above the first threshold (above investment grade), according to some embodiments. In some embodiments, upon selecting by a user a user-selectable icon, investment grade and status of the test may be displayed. FIG. 20B shows an example result of a financial condition test that indicates the credit rating is below the first threshold (below investment grade), according to some embodiments. FIG. 20C shows an example depicting that in response to a user hovering over a user-selectable icon, details regarding the credit rating comparison may be displayed. In some embodiments, the response may include displaying details of the bank's financial condition status. FIGS. 21A-B illustrate examples of results of a financial condition test that indicate a credit rating is below a first threshold and a second threshold, according to some embodiments. In some embodiments, if the balance (adjusted for any identified difference) held across all positive bank accounts is below a first threshold, then the user-selectable icon may be displayed as a given color and shape to visually indicate to the user that the balance is below the first threshold. In some embodiments, the user may select the user-selectable icon having the given color and shape to select an appropriate action that will update the status of the test.

### Review and Export

In some embodiments, review procedures may be completed when testing is finalized. In some embodiments, a test may be reviewed if the test is indicated as being complete without including identified differences or discrepancies. The audit team may include a supervisor. In some embodiments, the supervisor can review a completed test at any time. In some embodiments, supervisors may only review work performed by other team members. In some embodiments, it may not be possible for self-review. For example, for any test, which a supervisor performed the last action cannot be marked as reviewed by that same supervisor. In some embodiments, if a change is made to a reviewed test, then the test reverts to an unreviewed state. In some embodiments, the reviewed audit results may be exported for further verification or for performing additional or alternative actions selected or confirmed during the review process.

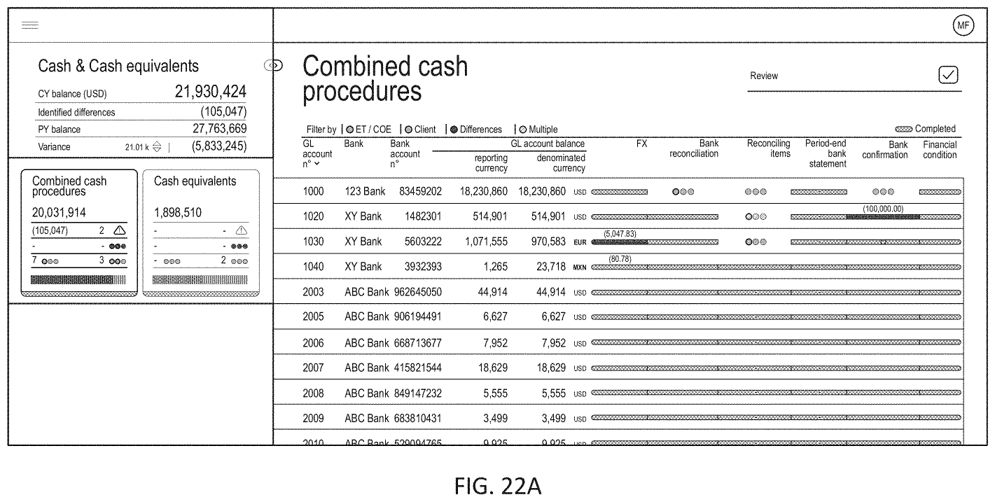

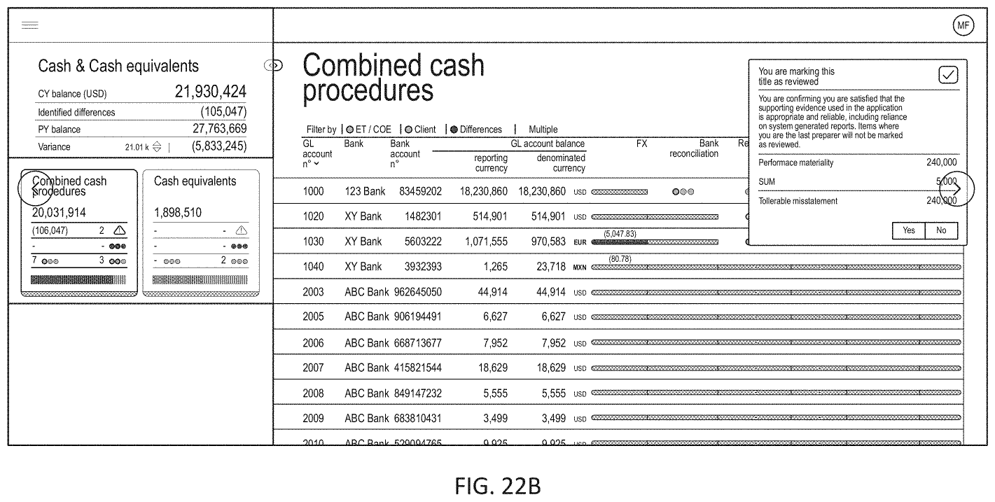

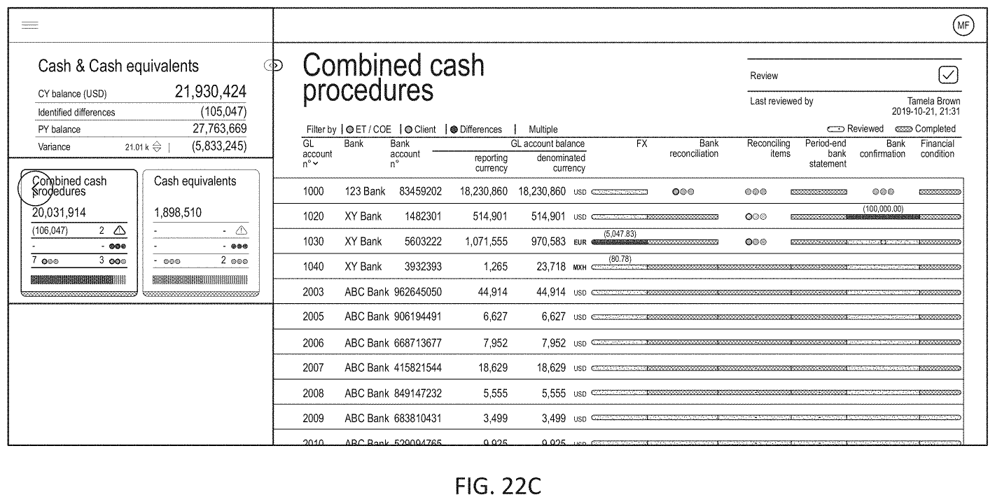

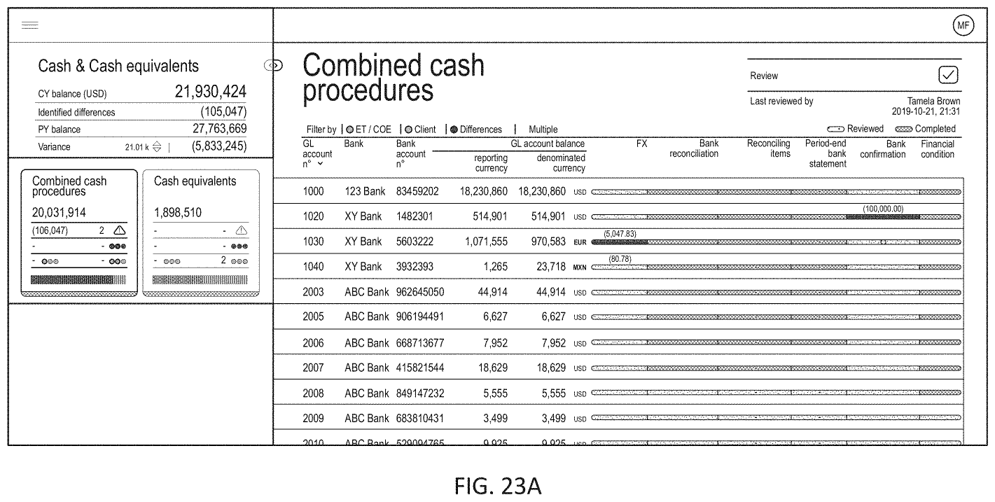

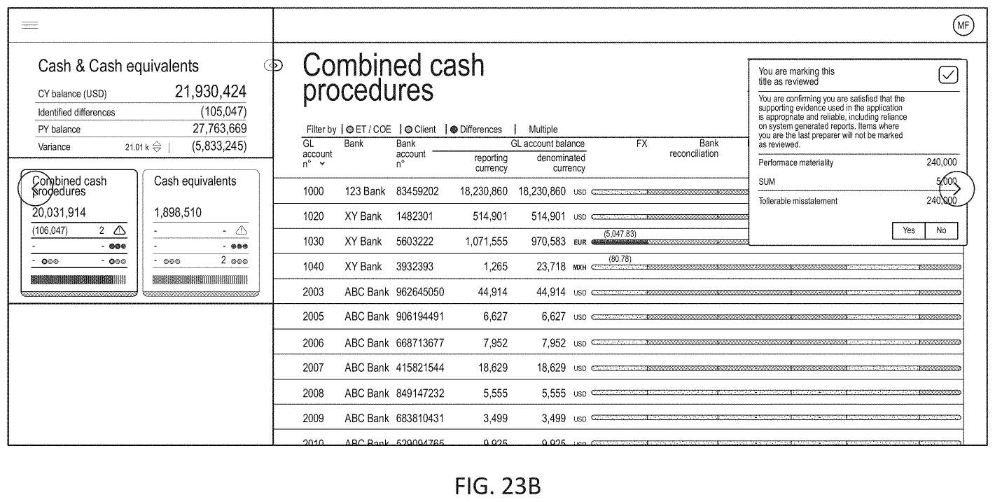

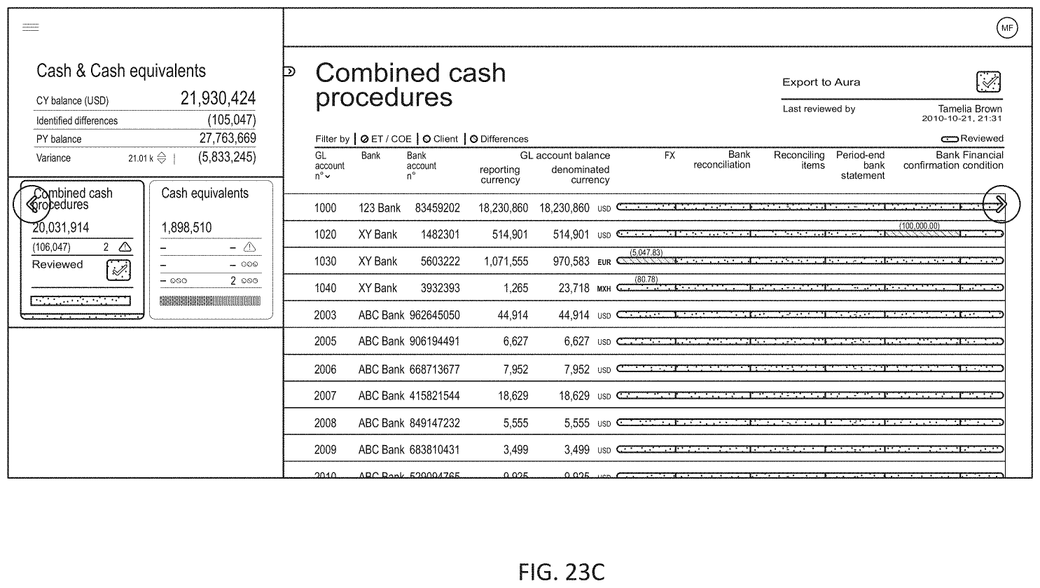

FIGS. 22A-22C illustrate examples of a partial review of the audit test, according to some embodiments. As shown in the example of FIG. 22B, a summary of key engagement may be displayed to a reviewer. In some embodiments, the summary of key engagement may include a confirmation icon selectable by the review to indicate that the test have been reviewed. As shown in the example of FIG. 22C, the reviewed timestamp and reviewer's name may be capture and displayed. In some embodiments, upon review of tests that have been completed and did not include an identified difference, the status of the test may be displayed in a color and shape that indicates the test has been completed, does not include identified differences, and has been reviewed. FIGS. 23A-23C illustrate examples of a final review of the audit test, according to some embodiments. In some embodiments, once all tests have been completed, a final review may be initiated. As shown in the example of FIG. 23B and similar to FIG. 22B, a summary of key engagement may be displayed to a reviewer. In some embodiments, the summary of key engagement may include a confirmation icon selectable by the review to indicate that the test have been reviewed. In some embodiments, once all tests have been reviewed, the dashboard changes to a final state in which the user-selectable icons may be updated to a first final color and a first final shape to indicate that the test is completed, reviewed, and did not include identified differences or the user-selectable icons may be a second final color and a second final shape to indicate that the test is completed, reviewed, and did include identified differences. As shown in the example of FIG. 23C, the results may be ready for export.

### Methods

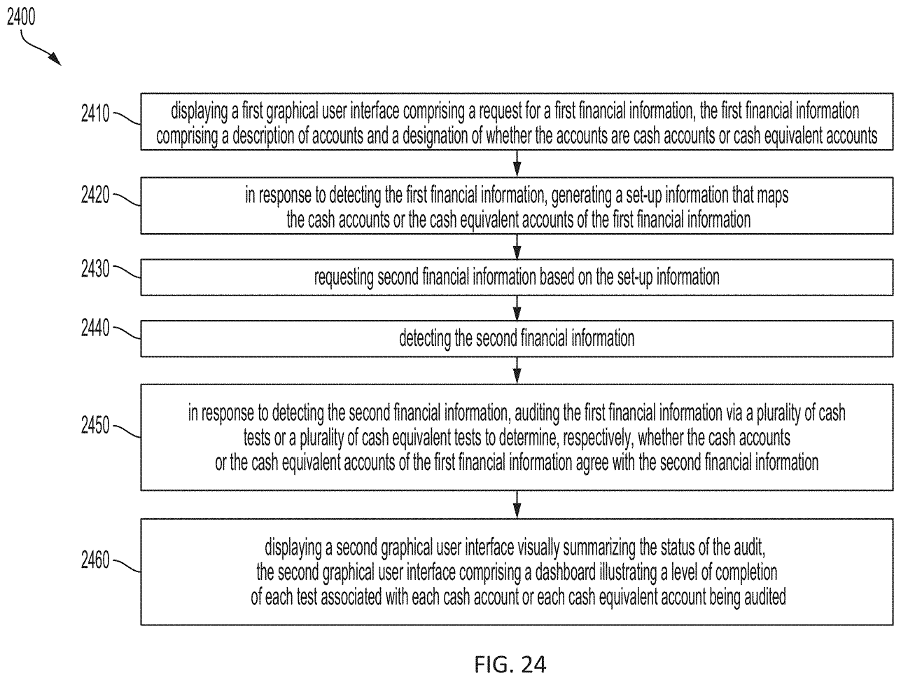

FIG. 24 shows an exemplary flowchart of a method 2400 for performing an audit of cash or cash equivalents and displaying a status of the audit at a computer system comprising one or more processor, memory, and a display, according to some embodiments. At step 2410, a first graphical user interface may be displayed. The first graphical user interface may comprise a request for a first financial information, the first financial information comprising a description of accounts and a designation of whether the accounts are cash accounts or cash equivalent accounts. In some embodiments, the first financial information may data received by an engagement module (such as engagement module 110). At step 2420, in response to detecting the first financial information, set-up information (such as set-up information 120) may be generated that maps the cash accounts or the cash equivalent accounts of the first financial information. In some embodiments, the set-up information may be generated based on a plurality of requests for financial information. The plurality of requests may include a series of requests. Each request may be made separately as needed. In some embodiments, responses to the plurality of requests may be used to map cash accounts or cash equivalent accounts of the first financial information. At step 2430, second financial information may be requested based on the set-up information. In some embodiments, the second financial information may include client deliverables such as bank reconciliations, bank statements, bank confirmation, and supporting evidence for bank reconciling items. At step 2440, second financial information may be detected. At step 2450, in response to detecting the second financial information, the first financial information may be audited via a plurality of cash tests or a plurality of cash equivalent tests to determine, respectively, whether the cash accounts or the cash equivalent accounts of the first financial information agree with the second financial information. At step 2460, a second graphical user interface may be displayed. The second graphical user interface may visually summarize the status of the audit and comprise a dashboard illustrating a level of completion of each test associated with each cash account or each cash equivalent account being audited.

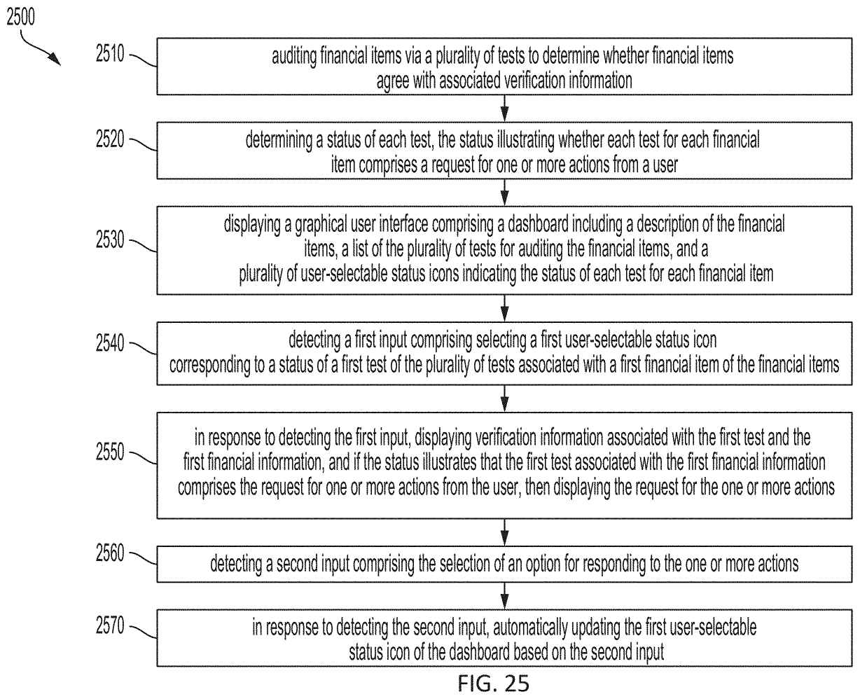

FIG. 25 shows a flowchart of an exemplary method 2500 for confirming an audit of financial information comprising cash or cash equivalent accounts at a computer system comprising one or more processors, memory, and a display, according to some embodiments. At step 2510, financial items may be audited via a plurality of tests to determine whether financial items agree with associated verification information. In some embodiments, financial items may include data provided to an engagement module (such as engagement module 110). In some embodiments the associated verification information may be client deliverables. At step 2520, a status of each test may be displayed. The status may illustrate whether each test for each financial item comprises a request for one or more actions from a user. At step 2530, a graphical user interface may be displayed comprising a dashboard including a description of the financial items, a list of the plurality of tests for auditing the financial items, and a plurality of user-selectable status icons indicating the status of each test for each financial item. At step 2540, a first input may be detected. The first input may comprise selecting a first user-selectable status icon corresponding to a status of a first test of the plurality of tests associated with a first financial item of the financial items. At step 2550, in response to detecting the first input, verification information associated with the first test and the first financial information may be displayed, and if the status illustrates that the first test associated with the first financial information comprises the request for one or more actions from the user, then the request for the one or more actions may be displayed. At step 2560, a second input may be detected. The second input may include the selection of an option for responding to the one or more actions. At step 2570, in response to detecting the second input, the first user-selectable status icon of the dashboard may be automatically updated based on the second input.

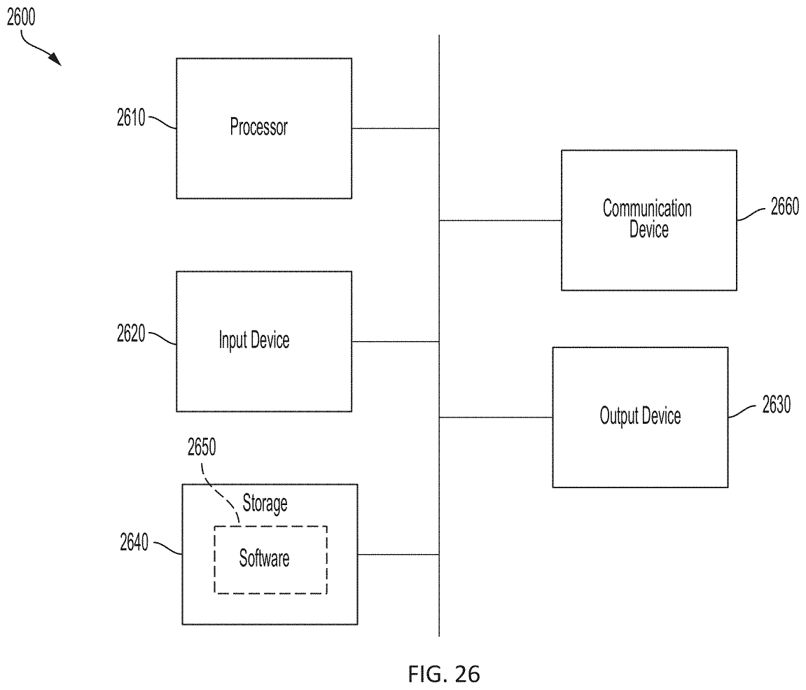

FIG. 26 illustrates an example of a computing device 2600 in accordance with some embodiments (such as system 100), or a computing device for implementing methods 2400 and 2500). Device 2600 can be a host computer connected to a network. Device 2600 can be a client computer or a server. As shown in FIG. 26, device 2600 can be any suitable type of microprocessor-based device, such as a personal computer, workstation, server, or handheld computing device (portable electronic device) such as a phone or tablet. The device can include, for example, one or more of processor 2610, input device 2620, output device 2630, storage 2640, and communication device 2660. Input device 2620 and output device 2630 can generally correspond to those described above and can either be connectable or integrated with the computer.

Input device 2620 can be any suitable device that provides input, such as a touch screen, keyboard or keypad, mouse, or voice-recognition device. Output device 2630 can be any suitable device that provides output, such as a touch screen, haptics device, or speaker.

Storage 2640 can be any suitable device that provides storage, such as an electrical, magnetic, or optical memory including a RAM, cache, hard drive, or removable storage disk. Communication device 2660 can include any suitable device capable of transmitting and receiving signals over a network, such as a network interface chip or device. The components of the computer can be connected in any suitable manner, such as via a physical bus or wirelessly.

Software 2650, which can be stored in storage 2640 and executed by processor 2610, can include, for example, the programming that embodies the functionality of the present disclosure (e.g., as embodied in the devices as described above).

Software 2650 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 2640, that can contain or store programming for use by or in connection with an instruction execution system, apparatus, or device.

Software 2650 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport readable medium can include, but is not limited to, an electronic, magnetic, optical, electromagnetic, or infrared wired or wireless propagation medium.

Device 2600 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 2600 can implement any operating system suitable for operating on the network. Software 2650 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A system for performing an audit of cash or cash equivalents and displaying a status of the audit, comprising:
a display;
one or more processors;
memory;
one or more programs configured for execution by the one or more processors, the one or more programs including instructions for:
displaying a first graphical user interface comprising a request for a first financial information, the first financial information comprising a description of accounts and a designation of whether the accounts are cash accounts or cash equivalent accounts;
in response to detecting the first financial information, generating a plurality of requests, receiving responses to the plurality of requests, and mapping the cash accounts or the cash equivalent accounts of the first financial information based on responses to the plurality of requests;
requesting second financial information based on the mapping of the cash accounts or the cash equivalent accounts of the first financial information;
detecting the second financial information;
in response to detecting the second financial information, auditing the first financial information via a plurality of cash tests or a plurality of cash equivalent tests to determine, respectively, whether the cash accounts or the cash equivalent accounts of the first financial information agree with the second financial information; and
displaying a second graphical user interface visually summarizing the status of the audit, the second graphical user interface comprising a dashboard illustrating a level of completion of each test associated with each cash account or each cash equivalent account being audited.

2. The system of claim 1, wherein the dashboard includes user-selectable status icons for illustrating a level of completion of each test for each cash account or cash equivalent account, and wherein the one or more programs includes instructions for automatically updating the level of completion of each test as the audit progresses.

3. The system of claim 2, wherein each user-selectable status icons has either a first shape to indicate that a corresponding test of the plurality of cash tests or of the plurality of cash equivalents tests is completed or a second shape to indicate that the corresponding test is pending.

4. The system of claim 3, wherein the first shape has either a first color to indicate that the corresponding test is completed and does not include a disagreement between the first financial information and the second financial information, a second color to indicate that the corresponding test is completed and reviewed, or a third color to indicate that the corresponding test is completed and includes at least one disagreement between the first financial information and the second financial information.

5. The system of claim 3, wherein the second shape has either a first color to indicate a possible disagreement, a second color to indicate one or more actions to be completed by a user, a third color to indicate one or more types of actions to be completed, or a fourth color to indicate a request for third financial information.

6. The system of claim 1, wherein the second financial information including one or more documents types, the document types including one or more of a bank reconciliation, a bank statement, a bank confirmation, and supporting evidence for a bank reconciling item for one or more cash account or cash equivalent account, each document type comprises a specific format.

7. The system of claim 6, wherein the specific format of a bank reconciliation includes a single CSV or Excel files per cash or cash equivalent account, the specific format of a bank statement includes a single CSV or Excel files, the specific format of a bank confirmation includes a PDF, and the specific format for supporting evidence for a bank reconciling item includes a PDF.

8. The system of claim 1, wherein the second graphical user interface comprises a first user-selectable summary of cash accounts and a second user-selectable summary of cash equivalent accounts, the first user-selectable summary and the second user-selectable summary are configured to automatically update as the audit progresses.

9. The system of claim 8, wherein the one or more programs including instructions for:
detecting a first input comprising selection of either the first user-selectable summary or the second user-selectable summary;
in response to detecting the first input comprising selection of the first user-selectable summary, displaying on the dashboard user-selectable status icons for illustrating a level of completion of each cash test for each cash account; and
in response to detecting the second input comprising selection of the second selectable summary, displaying on the dashboard user-selectable status icons for illustrating a level of completion of each cash equivalent test for each cash equivalent account.

10. The system of claim 8, wherein the second graphical user interface comprises a third summary including key points of cash and cash equivalent accounts.

11. The system of claim 1, wherein the dashboard comprises key client information associated with the cash accounts or the cash equivalent accounts.

12. The system of claim 1, the dashboard comprising a header including header icons configured to filter and sort the dashboard based on user selection of header icons.

13. A method for performing an audit of cash or cash equivalents and displaying a status of the audit, comprising:
at a computer system comprising one or more processor, memory, and a display:
displaying a first graphical user interface comprising a request for a first financial information, the first financial information comprising a description of accounts and a designation of whether the accounts are cash accounts or cash equivalent accounts;
in response to detecting the first financial information, generating a plurality of requests, receiving responses to the plurality of requests, and mapping the cash accounts or the cash equivalent accounts of the first financial information;
requesting second financial information based on the mapping of the cash accounts or the cash equivalent accounts of the first financial information;
detecting the second financial information;
in response to detecting the second financial information, auditing the first financial information via a plurality of cash tests or a plurality of cash equivalent tests to determine, respectively, whether the cash accounts or the cash equivalent accounts of the first financial information agree with the second financial information; and
displaying a second graphical user interface visually summarizing the status of the audit, the second graphical user interface comprising a dashboard illustrating a level of completion of each test associated with each cash account or each cash equivalent account being audited.

14. The method of claim 13, wherein the second graphical user interface comprises a first user-selectable summary of cash accounts and a second user-selectable summary of cash equivalent accounts that automatically update as the audit progresses, and the method comprising:
detecting a first input comprising selection of either the first user-selectable summary or the second user-selectable summary;
in response to detecting the first input comprising selection of the first user-selectable summary, displaying on the dashboard user-selectable status icons for illustrating a level of completion of each cash test for each cash account; and
in response to detecting the second input comprising selection of the second selectable summary, displaying on the dashboard user-selectable status icons for illustrating a level of completion of each cash equivalent test for each cash equivalent account.

15. A system for performing an audit of financial information comprising cash or cash equivalent accounts, comprising:
a display;
one or more processors;
memory;
one or more programs configured for execution by the one or more processors, the one or more programs including instructions for:
auditing financial items via a plurality of tests to determine whether the financial items agree with associated verification information;
determining a status of each test, the status illustrating whether each test for each financial item comprises a request for one or more actions from a user;
displaying a graphical user interface comprising a dashboard including a description of the financial items, a list of the plurality of tests for auditing the financial items, and a plurality of user-selectable status icons indicating the status of each test for each financial item;
detecting a first input comprising selecting a first user-selectable status icon corresponding to a status of a first test of the plurality of tests associated with a first financial item of the financial items;
in response to detecting the first input, displaying verification information associated with the first test and the first financial information, and if the status illustrates that the first test associated with the first financial information comprises the request for one or more actions from the user, then displaying the request for the one or more actions;
detecting a second input comprising the selection of an option for responding to the one or more actions; and
in response to detecting the second input, automatically updating the first user-selectable status icon of the dashboard based on the second input.

16. The system of claim 15, wherein the first test is configured for assessing one of foreign exchange, bank reconciliation, reconciling items, and bank confirmation.

17. The system of claim 15, wherein verification information includes a list of user-selectable supporting documents.

18. The system of claim 15, wherein the verification information is displayed on a pop-up panel.

19. The system of claim 15, wherein the verification information comprises a second status of the first test associated with the first financial information and the second status is configured to automatically update based on the second input.

20. A method for performing an audit of financial information comprising cash or cash equivalent accounts, comprising:
at a computer system comprising one or more processors, memory, and a display:
auditing financial items via a plurality of tests to determine whether financial items agree with associated verification information;
determining a status of each test, the status illustrating whether each test for each financial item comprises a request for one or more actions from a user;
displaying a graphical user interface comprising a dashboard including a description of the financial items, a list of the plurality of tests for auditing the financial items, and a plurality of user-selectable status icons indicating the status of each test for each financial item;
detecting a first input comprising selecting a first user-selectable status icon corresponding to a status of a first test of the plurality of tests associated with a first financial item of the financial items;
in response to detecting the first input, displaying verification information associated with the first test and the first financial information, and if the status illustrates that the first test associated with the first financial information comprises the request for one or more actions from the user, then displaying the request for the one or more actions;
detecting a second input comprising the selection of an option for responding to the one or more actions; and
in response to detecting the second input, automatically updating the first user-selectable status icon of the dashboard based on the second input.
